(19) United States
(12) Patent Application Publication
(10) Pub. No.: US 2026/0261993 A1
(43) Pub. Date: Sep. 3, 2026

(54) INITIAL ACCESS FOR PRACH TRANSMISSION

(71) Applicant: InterDigital Patent Holdings, Inc., Wilmington, DE (US)

(72) Inventors: Nazli Khan Beigi, Longueuil (CA); Young Woo Kwak, Woodbury, NY (US); Yugeswar Deenoo Narayanan Thangaraj, Chalfont, PA (US); Moon IL Lee, Melville, NY (US); Patrick Tooher, Montreal (CA); Tejaswinee Lutchoomun, Montreal (CA); Prasanna Herath, Laval (CA); Haseeb Ur Rehman, Winnipeg (CA)

(73) Assignee: InterDigital Patent Holdings, Inc., Wilmington, DE (US)

(21) Appl. No.: 19/165,367

(22) PCT Filed: Mar. 29, 2024
(86) PCT No.: PCT/US2024/022165

§ 371 Date: Sep. 15, 2025

Related U.S. Application Data
(60) Provisional application No. 63/457,029, filed on Apr. 4, 2023.

(51) Int. Cl. H04W 56/00; H04L 41/16; H04W 74/0833

(52) U.S. Cl. CPC H04W 56/0015; H04L 41/16; H04W 74/0833

(57) ABSTRACT

A wireless transmit receive unit (WTRU) may receive an indication of transmitted synchronization signal blocks (SSBs) comprised in an SSB burst and an indication of skipped SSBs in the SSB burst. The skipped SSBs are not transmitted by a base station in the SSB burst. The WTRU may determine to send an indication that the WTRU wants to use a skipped SSB for or after an initial access procedure. The WTRU may transmit a random access preamble using random access resources and receive at least one downlink transmission using a beam associated with the skipped SSB.

### CROSS-REFERENCE TO RELATED APPLICATIONS

This application claims the benefit of United States Provisional Patent Application No. 63/457,029 filed on Apr. 4, 2023, the entire contents of which are incorporated herein by reference.

### BACKGROUND

NR, or New Radio, is a 5G mobile communication standard developed by the 3rd Generation Partnership Project (3GPP) to provide high-speed and reliable wireless communication services. NR includes a variety of features and techniques to improve communication quality, increase network capacity, and reduce latency. Beam selection is one of the key features of NR that helps improve the performance of wireless communication. Beam selection involves selecting the optimal beam direction or beamforming for the transmission and reception of wireless signals. By using beamforming, NR can focus the transmission energy in a specific direction, which can improve the signal quality, reduce interference, and increase the range and capacity of the network.

### SUMMARY

A wireless transmit/receive unit (WTRU) may receive an indication of a set of one or more transmitted synchronization signal blocks (SSBs) and an indication of a set of one or more skipped SSBs in an SSB burst. Each of the one or more skipped SSBs may not be transmitted by a base station in the SSB burst. The WTRU may determine to send an indication that the WTRU wants to use a first skipped SSB of the one or more skipped SSBs. The WTRU may transmit a random access preamble using one or more random access resources. The one or more of the random access preamble or the one or more random access resources may be indicative of the first skipped SSB. The WTRU may receive at least one downlink transmission using a beam associated with the first skipped SSB.

The WTRU may also receive configuration information associated with the one or more transmitted SSBs. The configuration information may include a list of candidate beams. The list of candidate beams may include the beam associated with the first skipped SSB.

In one embodiment, the configuration information may include beam indexes, an azimuth angle, an elevation angle, or a boresight angle. The random access preamble may be transmitted using a beam associated with a first transmitted SSB of the set of one or more transmitted SSBs, and the random access preamble or the one or more random access resources associated with the first transmitted SSB may be indicative of the first skipped SSB.

In one example, the one or more random access resources may include a first random access resource and a second random access resource. The first random access resource may be associated with a first transmitted SSB and the second random access resource may be associated with the first skipped SSB. The WTRU may be further configured to receive a configuration indicating whether SSB skipping is enabled.

The WTRU may also be configured to use an artificial intelligence (AI)/machine learning (ML) model to predict a list of preferred predicted SSBs from the set of one or more skipped SSBs. The one or more random access resources may be based on the one or more transmitted SSBs, the one or more skipped SSBs, or a combination of the one or more transmitted SSBs and the one or more skipped SSBs.

In an example, the first skipped SSB of the one or more skipped SSBs may be used for or after an initial access procedure. An indication sent in a random access message three using the one or more random access resources may be indicative of the first skipped SSB.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of skipping the transmission of a subset of SSBs.

### DETAILED DESCRIPTION

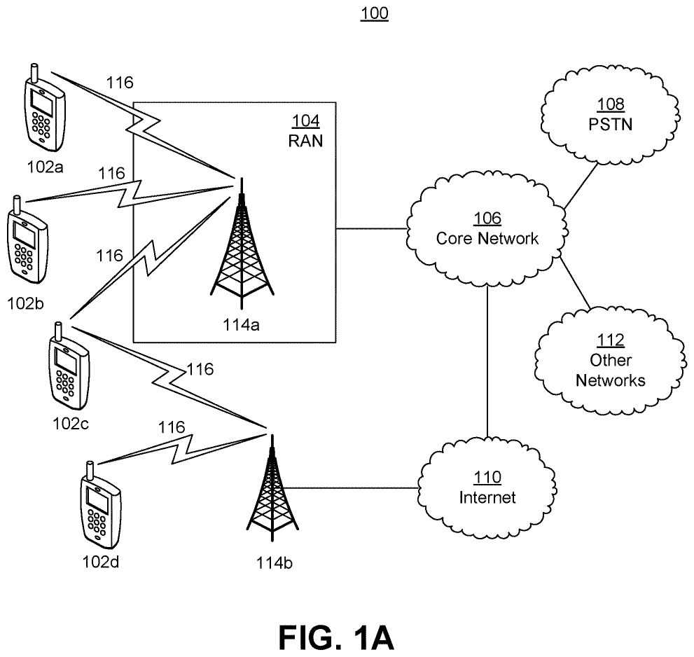

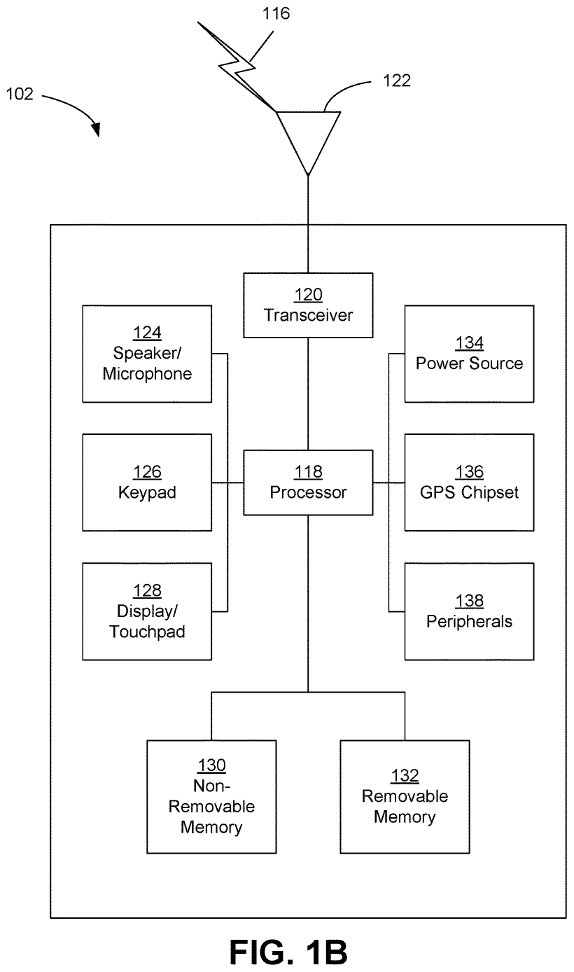

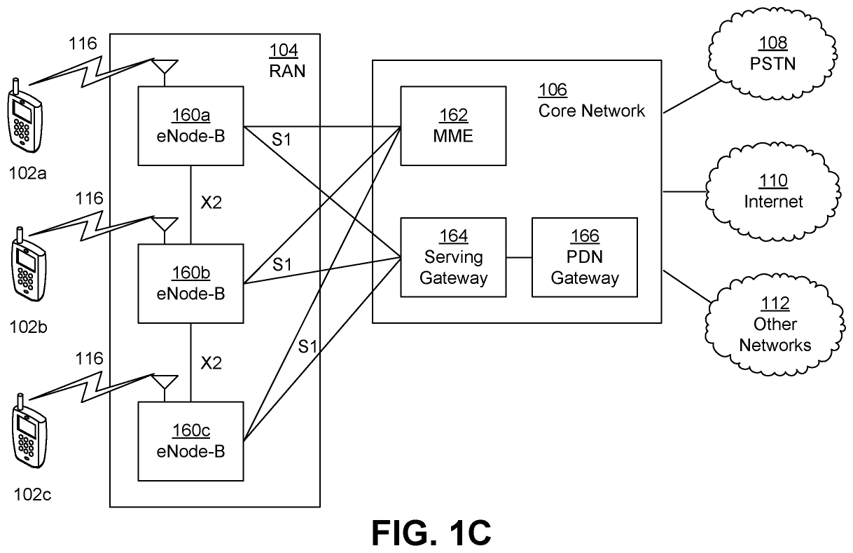

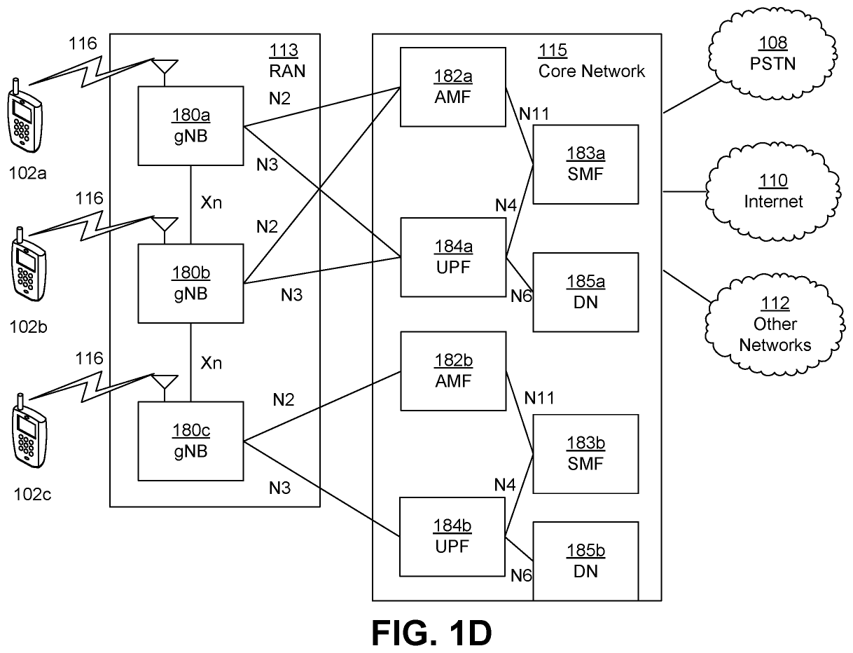

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUS 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAS that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802. 11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC). Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b.

The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Beam management may be implemented as one of the target use-cases for AI/ML for air interface. This technology may improve performance and/or complexity in conventional beam management aspects, including beam prediction in time, and/or spatial domain for overhead and latency reduction, beam selection accuracy improvement, and so forth.

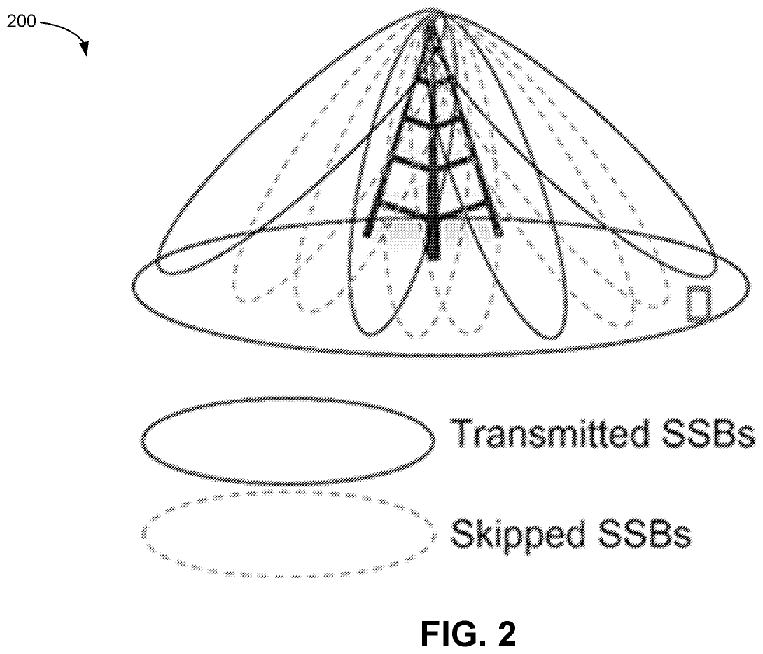

In legacy NR, the gNB could select a set of SS/PBCH blocks (SSB) to be transmitted in SSB bursts, where the list of SSBs that are transmitted in a SSB burst could be indicated via ssb-PositionsInBurst in SIB1. The transmission of SSB beams (e.g., up to 64) may cause a relatively large payload and/or overhead on the gNB's performance. In case the number of transmitted SSBs could be reduced, it could impact the system performance and latency. As such, the gNB could skip transmission of some SSBs and transmit a subset of SSBs and the WTRUs could predict (e.g., by using AIML systems) the best beam based on the transmitted SSBs. An example of such scenario is shown in FIG. 2, where the gNB transmits a subset of beams (shown as solid-line beams) and skips transmission of a subset of the beams (shown as dashed-line beams). This results in different WTRU behavior in predicting the SSB beams and the subsequent initial access procedures. The WTRU may need to determine the inputs, conditions, measurements, etc. for inference, validation and so forth. Therefore, described herein are embodiments related to skipping the SSBs and enhancement in NR AI/ML beam management.

A WTRU may efficiently perform initial access in systems with skipped SSBs. Embodiment are described herein for initial access in AIML scenarios with skipped SSBs. In an example, a WTRU may be configured with a set of transmitted SSB beams and a set of predicted SSB beams. The WTRU may select a predicted beam for which it performs initial access (e.g., based on predicted RSRP). A WTRU may initiate an initial access by sending the PRACH preamble on the PRACH resources, where the PRACH resources may be selected based on one or more of: an associated detected SSB beam, predicted SSB beams, and/or a combination of multiple detected and/or predicted SSB beams. To perform initial access in AIML systems with skipped SSBs, a procedure may be performed to predict SSB beams in systems with skipped SSBs (e.g., as described further herein, using Set A and Set B in systems with skipped SSBs). PRACH preamble transmission may be performed in AIML scenarios with skipped SSBs.

In an embodiment, a WTRU may initiate an initial access by sending the PRACH preamble on the PRACH resources, where the PRACH resources may be selected based on an associated detected SSB beam or actually transmitted SSBs. For example, the WTRU may be configured to transmit the PRACH preamble on the resources corresponding to an associated detected SSB beam. The WTRU may indicate the preferred predicted beam to the gNB as a function of PRACH preamble selection or Msg3 transmission, or in a transmission performed after RA procedure. In RAR, for example, the gNB may indicate whether the predicted beam is accepted (by sending the same RAPID (Preamble ID) or another ID to indicate to WTRU to select another beam (detected beam or predicted beam). For example, this may apply in a situation where the gNB did not send an SSB due to gNB implementation (e.g., gNB turns off those beams for power consumption enhancement). For example, the gNB may not want to receive anything at those beams as well. The gNB may not use that beam unless a WTRU asks for it.

A WTRU may initiate an initial access by sending the PRACH preamble on the PRACH resources, where the PRACH resources may be selected based on predicted SSB beams or skipped SSBs. For example, the WTRU may be configured to transmit the PRACH preamble on the resources corresponding to one of the predicted SSB beams (e.g., the one with the highest RSRP). The WTRU may be configured or determined to use one or more Random Access parameters (e.g., for the PRACH transmission and RAR reception (e.g., number of retransmissions of PRACH preamble, power ramp-up value, and so forth.))

A WTRU may initiate an initial access by sending the PRACH preamble on the PRACH resources, where the PRACH resources may be selected based on a combination of multiple detected and/or predicted SSB beams or a combination of actually transmitted SSBs and skipped SSBs. For example, the WTRU may be configured to transmit the PRACH preamble on multiple resources corresponding to the detection and/or prediction of more than one SSB beam (e.g., based on the configurations received for the detected SSB, e.g., in the direction of the detected SSB). For example, the first resource may indicate that the detected SSB and a first predicted SSB beam are both preferred beams, the second resource may indicate that the detected SSB and a second predicted SSB beams are preferred beams, and so forth. In case the gNB receives a PRACH on the resources corresponding to an SSB beam that was not actually transmitted, the gNB may expect that the SSB may have been selected based on the prediction.

The WTRU may monitor the PDCCH scrambled with RA-RNTI to detect RAR within the period RAR-Window corresponding to the transmitted PRACH and/or associated detected and/or predicted SSB beams. In case the WTRU receives a RAR, the WTRU may continue with initial access (e.g., transmission of Msg3, etc.).

Embodiments are described herein for WTRU behavior in case of failed PRACH transmission. For example, a WTRU may receive or be configured with a set of transmitted SSB beams or actually transmitted SSBs and a set of predicted SSB beams. The predicted SSBs may not be transmitted by a base station. The WTRU may select a predicted beam or SSB (e.g., based on predicted RSRP), for which it may perform initial access (e.g., PRACH preamble transmission). The WTRU may use transmit the PRACH preamble or random access preamble using a beam associated with the predicted beam or predicted SSB. In an example, the WTRU may monitor the PDCCH scrambled with RA-RNTI that schedules a RAR to detect RAR within the period RAR-Window corresponding to the transmitted PRACH and/or associated detected and/or predicted SSB beams. In case the WTRU receives a RAR, the WTRU may continue with initial access (e.g., transmission of Msg3, etc.). If the WTRU does not receive a RAR within a configured time window or based on a counter, the WTRU may employ one or more of the following methods. In one method the WTRU may switch the SSB beam to another SSB beam from the list of predicted SSB beams and so on up to k beams (e.g., selected in the descending order of RSRP) or select another predicted SSB and transmit a random access preamble using a beam associated with the another predicted SSB. The set of predicted SSBs may be sorted in a descending order of reference signal received power (RSRP) and a predicted SSB is selected from the sorted list. In one method the WTRU may transmit PRACH (e.g., only) for the detected beam or select an actually transmitted SSB and transmit a random access preamble using a beam associated with the actually transmitted SSB. In one method the WTRU may wait for legacy SSB burst with each SSB beam transmitted or receive subsequent SSB burst. For example, the gNB may have SSB bursts with each intended SSB beam (ssb-SetA) transmitted maybe with longer period. For example, after M SSB bursts with skipped SSB beams, the gNB will transmit an SSB burst with each intended beam transmitted. The subsequent SSB burst may include actually transmitted SSBs and actual transmissions of the predicted SSBs. So based on the subsequent SSB burst, the WTRU may wait for maximum duration of M SSB bursts (e.g., M is configured in MIB or SIB1) and then detect or select the best SSB beam or a new SSB for initial access accordingly. In one method the WTRU may reject this cell and attempt to detect or select another SSB block in a different synchronization raster and/or another cell for initial access.

Embodiments are described herein for a correction and confirmation procedure for the predicted beam based on received RAR. For example, a WTRU may determine a predicted SSB beam is the best beam (e.g., based on predicted RSRP) based on detected and/or received SSB beams and an AIML model. The WTRU may start initial access procedure by sending PRACH preamble for the predicted SSB beam (e.g., in time and freq. resources associated with the predicted SSB beam). The WTRU may monitor to receive RAR in the RAR window.

In an example, after receiving RAR (e.g., RAR PDCCH and/or RAR PDSCH on a beam QCL-ed with the predicted SSB beam), the WTRU may measure the RSRP (e.g., based on reference signal in RAR message, e.g., DMRS). The WTRU may compare the measured RSRP based on received RAR with the predicted RSRP for the predicted SSB. For example, the WTRU may be configured or receive (e.g., via MIB, SIB1, and/or RAR) one or more parameters regarding offsets and/or thresholds for comparing the RSRP measured based on RAR (e.g., PDCCH DMRS, or PDSCH DMRS) with the RSRP predicted for SSB. The motivation here, for example, may be that the RSRP measured from SSB and DMRS are different. Also, the transmission power for SSB and DMRS may have a large difference. Therefore, the gNB may provide the offset/threshold (e.g., 10 dB) to compare the values.

In an example, the WTRU may verify whether the prediction was accurate based on the comparison and one or more of the offsets or thresholds (e.g., determine whether the difference between the predicted RSRP and measured RSRP is lower than a threshold (e.g., 10 dB). For example, in case the difference between the predicted RSRP with the measured RSRP is lower than a (pre)configured threshold, the WTRU may determine that the predicted beam is accurate enough and therefore may continue using the predicted beam for transmission of further signals (e.g., Msg3). For example, in case the difference between the predicted RSRP with the measured RSRP is higher than a (pre)configured threshold, the WTRU may determine that the predicted beam is not accurate enough. The WTRU may reject the predicted beam and continue with selecting another beam or follows procedures considered for failed PRACH transmission.

In an example, (e.g., alternatively) in case the WTRU has sent the PRACH based on combination of multiple (e.g., two) detected and/or predicted SSB beams (as further discussed herein), the WTRU may receive multiple (e.g., two) RAR messages for the corresponding beams. For example, the WTRU may measure the RSRP for each of the received RAR messages and determines the best beam (e.g., with higher RSRP). The WTRU may transmit further signals (e.g., Msg 3) based on the selected best beam.

For the proposed embodiments herein, there are aspects, described below, which are common to all embodiments. Artificial intelligence (AI) may be defined as the behavior exhibited by machines. Such behavior may e.g., mimic cognitive functions to sense, reason, adapt and act. Machine learning (ML) may refer to type of algorithms that solve a problem based on learning through experience (‘data’), without explicitly being programmed (‘configuring set of rules’). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach 16 may use a combination of a small amount of labeled data with a large amount of unlabeled data during training. In this regard semi-supervised learning falls between unsupervised learning (with no labeled training data) and supervised learning (with labeled training data). Deep learning (DL) may refer to class of machine learning algorithms that employ artificial neural networks (specifically DNNs) which were loosely inspired from biological systems. The Deep Neural Networks (DNNs) are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in variety of domains, e.g., speech, vision, natural language etc. and for various machine learning settings supervised, un-supervised, and semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

A WTRU may transmit or receive a physical channel or reference signal according to at least one spatial domain filter. The term “beam” may be used to refer to a spatial domain filter. The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block. The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal. A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”. The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association 17 between a CSI-RS or SS block and a DM-RS by an index to a set of TCI states configured by RRC and/or signaled by MAC CE. Such indication may also be referred to as a “beam indication”.

Herein, a TRP (e.g., transmission and reception point) may be interchangeably used with one or more of TP (transmission point), RP (reception point), RRH (radio remote head), DA (distributed antenna), BS (base station), a sector (of a BS), and/or a cell (e.g., a geographical cell area served by a BS). Herein, Multi-TRP may be interchangeably used with one or more of MTRP, M-TRP, and multiple TRPs.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following: CSI Report Configuration, including one or more of: CSI Report Configuration, CSI-RS Resource Set, and/or NZP CSI-RS Resources. CSI Report Configuration may include one or more of the following: CSI report quantity, e.g., Channel Quality Indicator (CQI), Rank Indicator (RI), Precoding Matrix Indicator (PMI), CSI-RS Resource Indicator (CRI), Layer Indicator (LI), etc. ; CSI report type, e.g., aperiodic, semi persistent, periodic; CSI report codebook configuration, e.g., Type I, Type II, Type II port selection, etc.; and/or CSI report frequency. CSI-RS Resource Set may include one or more of the following: CSI Resource settings; NZP-CSI-RS Resource for channel measurement; NZP-CSI-RS Resource for interference measurement; and/or CSI-IM Resource for interference measurement. NZP CSI-RS Resources may include one or more of the following: NZP CSI-RS Resource ID, Periodicity and offset; QCL Info and TCI-state; and/or Resource mapping (e.g., number of ports, density, CDM type, etc.).

In an example, a WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals. CSI-RSRP may be measured based on the linear average over the power contribution of the resource elements (RE) that carry the respective CSI-RS. The CSI-RSRP measurement may be configured within measurement resources for the configured CSI-RS occasions. SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers. CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth). Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth). Sounding reference signals RSRP (SRS-RSRP) may be measured based on the linear average over the power contribution of the resource elements (RE) that carry the respective SRS. Secondary synchronization signal reference signal received quality (SS-RSRQ) may be measured based on measurements on the reference signal received power (SS-RSRP) and received signal strength (RSSI). In an example, the SS-RSRQ may be calculated as the ratio of NxSS-RSRP/NR carrier RSSI, where N may be determined based on the number of resource blocks that are in the corresponding NR carrier RSSI measurement bandwidth. As such, the measurements to be used in the numerator and denominator may be over the same set of resource blocks. CSI reference signal received quality (CSI-RSRQ) may be measured based on measurements on the reference signal received power (CSI-RSRP) and received signal strength (RSSI). In an example, the SS-RSRQ may be calculated as the ratio of NxCSI-RSRP/CSIRSSI, where N may be determined based on the number of resource blocks that are in the corresponding CSI-RSSI measurement bandwidth. As such, the measurements to be used in the numerator and denominator may be over the same set of resource blocks. In an example, a CSI report configuration (e.g., CSI-ReportConfigs) may be associated with a single BWP (e.g., indicated by BWP-Id), wherein one or more of the following parameters are configured: CSI-RS resources and/or CSI-RS resource sets for channel and interference measurement; CSI-RS report configuration type including the periodic, semi-persistent, and aperiodic; CSI-RS transmission periodicity for periodic and semi-persistent CSI reports; CSI-RS transmission slot offset for periodic, semi-persistent and aperiodic CSI reports; CSI-RS transmission slot offset list for semi-persistent and aperiodic CSI reports; time restrictions for channel and interference measurements; Report frequency band configuration (wideband/subband CQI, PMI, and so forth); thresholds and modes of calculations for the reporting quantities (CQI, RSRP, SINR, LI, RI, etc.); codebook configuration; group based beam reporting; CQI table; subband size; non-PMI port indication; Port Index; and so forth.

In an example, a CSI-RS Resource Set (e.g., NZP-CSI-RS-ResourceSet) may include one or more of CSI-RS resources (e.g., NZP-CSI-RS-Resource and CSI-ResourceConfig), wherein a WTRU may be configured with one or more of the following in a CSI-RS Resource: CSI-RS periodicity and slot offset for periodic and semi-persistent CSI-RS Resources; CSI-RS resource mapping to define the number of CSI-RS ports, density, CDM-type, OFDM symbol, and subcarrier occupancy; the bandwidth part to which the configured CSI-RS is allocated; and/or the reference to the TCI-State including the QCL source RS(s) and the corresponding QCL type(s), In an example, one or more of following configurations may be used for a RS resource set. For example, a WTRU may be configured with one or more RS resource sets. The RS resource set configuration may include one or more of following: RS resource set ID; one or more RS resources for the RS resource set; repetition (e.g., on or off); aperiodic triggering offset (e.g., one of 0-6 slots); and/or TRS info (e.g., true or not).

One or more of following configurations may be used for a RS resource. For example, a WTRU may be configured with one or more RS resources. The RS resource configuration may include one or more of following: RS resource ID; resource mapping (e.g., REs in a PRB); power control offset (e.g., one value of −8, . . . , 15); power control offset with SS (e.g., −3 dB, 0 dB, 3 dB, 6 Db); scrambling ID; periodicity and offset; and/or QCL information (e.g., based on a TCI state).

In the following, a property of a grant or assignment may consist of at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and/or any parameter provided in a DCI, by MAC or by RRC for the scheduling the grant or assignment.

In the following, an indication by DCI may consist of at least one of the following: an explicit indication by a DCI field or by RNTI used to mask or scramble the CRC of the DCI; and/or an implicit indication by a property such as DCI format, DCI size, Coreset or search space, Aggregation Level, first resource element of the received DCI (e.g., index of first Control Channel Element), where the mapping between the property and the value may be signaled by RRC or MAC. Receiving or monitoring for a DCI with or using an RNTI may mean that the CRC of the DCI is masked or scrambled with the RNTI.

Herein, a signal may be interchangeably used with one or more of following: sounding reference signal (SRS); channel state information—reference signal (CSI-RS); demodulation reference signal (DM-RS); phase tracking reference signal (PT-RS); and/or synchronization signal block (SSB).

Herein, a channel may be interchangeably used with one or more of following: physical downlink control channel (PDCCH); physical downlink shared channel (PDSCH); physical uplink control channel (PUCCH); physical uplink shared channel (PUSCH); physical random access channel (PRACH); and/or the like.

Herein, a signal, channel, and message (e.g., as in DL or UL signal, channel, and message) may be used interchangeably. Herein, RS may be interchangeably used with one or more of RS resource, RS resource set, RS port and RS port group. Herein, RS may be interchangeably used with one or more of SSB, CSI-RS, SRS, and DM-RS, TRS, PRS, and PTRS.

Herein, time instance, slot, symbol, and subframe may be used interchangeably. Herein, the terms SSB, SS/PBCH block, PSS, SSS, PBCH, and MIB may be used interchangeably. Herein, SSB, SSB beam, and SSB index may be used interchangeably. Herein, the proposed solutions for beam resources prediction may be used for beam resources belonging to a single or multiple cells as well as single or multiple TRPs.

Herein, CSI reporting may be interchangeably used with CSI measurement, beam reporting and beam measurement. Herein, a RS resource set may be interchangeably used with a beam group.

The embodiments described herein may share initial common embodiment components, such as, for example, SS/PBCH Block, MIB, and SIB; configuration of measurement and estimation sets; and Set B requirements. In an embodiment, a WTRU may receive a physical broadcast channel (PBCH). The PBCH may be part of an SS/PBCH block (SSB). The PBCH may carry system information. The PBCH may include or carry a master information block (MIB). The term MIB may be used to represent the content, information, payload, and/or bits carried by the PBCH. PBCH and MIB may be used interchangeably herein. For example, upon detection and/or reception of an SS/PBCH block, the WTRU may use the information in MIB on the time and/or frequency resources to find one or more system information blocks (SIB). The term SIB may be used to represent the content, information, payload, and/or bits. In an example, one or more cell (re)selection parameters may be broadcasted in SIB (e.g., SIB1, SIB2, SIB3, and so forth), where the WTRU may detect and/or receive from the serving and/or the newly detected cells.

In an embodiment, a WTRU may be configured with one or more sets of reference signal (RS) resources and/or beams (or beam-pairs). Each RS resource or beam or beam-pair may be associated with a transmission from a beam of specific beam parameters (e.g., beam direction and beamwidth). The WTRU may be configured with the associated beams and/or RS resources and the beam parameters. In an example, a WTRU may be configured with a first set of RS resources or beams or beam-pairs that may cover the entire RS resource-space or beam-space or beam-pair-space. The WTRU may determine or select a set A and a set B such that the union of set A and set B covers the entire RS-resource-space or beam-space or beam-pair-space. In an example, set A and set B may be mutually exclusive. In an example, a set B includes RS resources on which the WTRU may perform measurements to obtain 1) direct measurement values for a first set of beams or beam-pairs (e.g., one-to-one mapping between an RS resource and a beam or beam-pair) and 2) estimated measurement values for a second set of beams or beam-pairs (e.g., many-to-one mapping between RS resources and a beam or beam-pair and possibly using AI/ML estimation model).

In an embodiment, a WTRU may be configured with one or more sets of RSs resources associated to each beam. For example, a WTRU may be configured with a first beam associated with two sets of RSs: a first set including a single RS resource and a second set including multiple RS resources. A WTRU may determine measurements associated with the beam via direct measurements of the RS resources in the first set or via estimation obtained from measurements of the RS resources in the second set. A WTRU may determine a measurement set of RS resources (e.g., a set B) such that for every beam for which it must obtain measurements (either directly or via estimation), the set B contains at least one of the two sets of RS resources associated to the beam. Herein, a Set B may be interchangeably used with a set of one or more: RS resource sets, beams, beam-pairs, beam RS resources, RS resources, and/or a beam pattern. Herein, a Set A may be interchangeably used with a set of one or more: RS resource sets, beams, beam-pairs, beam RS resources, RS resources, and/or a beam pattern.

Initial Access may be performed in AIML systems with skipped SSBs. In an embodiment, sets of SSBs, designated Set A and Set B, may be determined in systems with skipped SSBs. A WTRU may be (pre)configured with the maximum number of SSBs (e.g., within an SSB burst) in a cell. The maximum number of SSBs may be explicitly configured for the WTRU (e.g., via MIB, SIB, etc.). Alternatively, the maximum number of SSBs may be implicitly indicated to the WTRU, for example based on the used frequency range. In an example, if the WTRU is operating in a first frequency range (e.g., FR1), the WTRU may determine the maximum number of the SSBs within a SSB burst to be a first value (e.g., maximum eight SSBs); if the WTRU is operating in a second frequency range (e.g., FR2), the WTRU may determine the maximum number of the SSBs within a SSB burst to be a second value (e.g., maximum 64 SSBs), and so forth.

A WTRU may detect one or more SSBs within an SSB burst (e.g., during initial access, cell (re)selection, etc.). In an example, considering the maximum number of SSBs within an SSB burst, a subset of SSBs may actually be planned, configured, required, expected, and/or designed to be used in an SSB burst (e.g., in a cell). The set of the planned SSBs may be a set of SSBs that may cover the entire SSB resource-space or beam-space. In an example, the number of planned SSBs may be lower than or equal to the maximum number of SSBs, that is determined at the network based on the SSBs' coverage space, correlation of the beams, and so forth. The WTRU may be provided and/or configured with the number of planned SSBs and/or the corresponding SSB beam indexes, where the WTRU may consider the set of planned SSBs as Set A.

The WTRU may receive, be provided, or be configured with the information on actual transmitted SSBs within an SSB burst. The information may include the number of actual transmitted SSB beams, the SSB index corresponding to the actual transmitted SSB beams, and so forth. The WTRU may consider the set of actual transmitted SSBs as Set B, where Set B may be a subset of configured Set A. In an example, (e.g., alternatively) the WTRU may determine, be provided, or configured with a set of skipped SSBs that are a subset of Set A which are not actually being transmitted in the corresponding SSB burst. In an example, the union of Set B and the set of skipped beams may be equal to Set A.

FIG. 2 is a diagram illustrating an example of a system 200 with skipped SSBs, As an example, as shown in FIG. 2, the solid-lined beams indicate the Set B, that is the actual transmitted beams; the dashed-lined beams indicate the skipped beams, and Set A is the union of Set B and the skipped beams. The terms “transmitted SSBs” and “actually transmitted SSBs” may be used interchangeably. The terms “SSBs that are not transmitted” and “skipped SSBs” may be used interchangeably.

Procedures may be performed to predict SSB beams in systems with skipped SSBs. In an example solution, a WTRU may perform one or more of the following. A WTRU may detect one or more SSBs (e.g., during initial access) or receive an indication of a set of one or more actually transmitted SSBs in an SSB burst. A WTRU may select a first SSB with the highest received power (e.g., RSRP). The WTRU may determine the time and frequency synchronization based on the first SSB. The WTRU may decode the PSS, SSS, PBCH, PBCH-DMRS, SSB index, MIB, and SIB1 for the first SSB. The WTRU may receive configuration on or indicating whether SSB skipping is enabled at the gNB (e.g., via MIB or SIB1), or receive an indication of a set of one or more skipped SSBs in an SSB burst. The WTRU may receive the list of each SSB that is configured by the gNB (e.g., Set A) (e.g., via ssb-SetA in SIB1). The WTRU may receive the list of SSBs that are being transmitted (e.g., Set B) (e.g., via ssb-SetB and/or ssb-PositionsInBurst in SIB1). The WTRU may receive configuration information associated with each transmitted SSB (ssb-SetB) including a list of candidate beams (e.g., ssb-candidate) that WTRU may use as inference input, including information on the association of one or more transmitted SSBs with one or more SSBs that are not transmitted. The list of dandidate beams may include beams associated with the SSBs that are not transmitted. The set of candidate beams may be indicated per SSB beam in Set B. Configuration information may include the beam indexes, azimuth angle, elevation angle, boresight angle, and so forth. In an example, for each transmitted SSB beam from ssb-SetB, the WTRU may receive a list of candidate SSB beams (e.g., ssb-candidate), where the candidate beams are a subset of Set A. The WTRU may determine which SSB beams are associated (e.g., neighbor, adjacent, or correlated) with the detected beam from ssb-SetB, based on the list of candidate SSB beams (ssb-candidate). The WTRU may use AIML model to predict a set/list of N (best) predicted SSB beams from the list of the SSB beams that were not transmitted. The number of the beams that may be predicted may depend on the AIML model. The WTRU may use the list of N predicted beams along with the received list of candidate SSB beams (e.g., ssb-candidate) to select k best SSB beams. The k best SSB beams in the list may be ordered (e.g., based on the descending order of RSRP, RSRQ, etc.) for the predicted SSB beams according to the AIML model. The set of predicted SSBs may be sorted in a descending order of reference signal received power (RSRP) and a predicted SSB is selected from the sorted list. The WTRU may initiate initial access (e.g., by sending the PRACH preamble) on the PRACH resources. The WTRU may receive one or more information configurations on one or more SSB-specific (e.g., beam-specific) parameters (e.g., paging search space, etc.) for the predicted SSB, as part of initial access procedure (e.g., via RAR, Msg4, and/or MsgB). The gNB may know that the WTRU has predicted the predicted SSB based on received PRACH, as the corresponding SSB was not transmitted in the first place.

A WTRU may support an initial access procedure based on predicted qualities (e.g., predicted RSRPs) and measured qualities (e.g., measured RSRP). The WTRU may detect one or more SSBs (e.g., during initial access) and select a first number of SSBs with the highest quality (e.g., received power (RSRP), RSRQ, SINR, hypothetical BLER, etc.). The first number of SSBs may be determined based on one or more of: Quality threshold, Predefined maximum number, and/or UE capability.

The first number of SSBs may be determined based on Quality threshold. For example, the WTRU may determine one or more SSBs which have higher quality than a threshold. The threshold may be predetermined or configured (e.g., by gNB). The first number of SSBs may be determined based on Predefined maximum number. For example, a maximum number of determined SSBs (e.g., M1) may be predetermined or configured. For example, if number of SSBs which have higher quality than the threshold is M2, which is larger than M1, then the WTRU may determine best M1 SSBs from M2 SSBs. The first number of SSBs may be determined based on UE capability. For example, a maximum number of determined SSBs (e.g., M3) may be limited based on the WTRU capability. For example, if number of SSBs which have higher quality than the threshold is M2, which is larger than M3, then the WTRU may determine best M3 SSBs from M2 SSBs.

The WTRU may determine the time and frequency synchronization based on the first number of SSBs.

Based on the determined time and frequency synchronization, the WTRU may decode one or more initial access related signals (e.g., PSS, SSS, PBCH, PBCH-DMRS, SSB index, MIB, and SIB1) for the first number of SSBs.

Based on the decoded one or more initial access related signals, the WTRU may receive a configuration on/indicating whether SSB skipping is enabled at the gNB (e.g., via MIB or SIB1).

The gNB may indicate one or more of the following based on one or more of MIB, SIB, RRC, MAC CE and DCI: whether SSB skipping is enabled or not; type of AI/ML model; number of SSBs in Set A for initial access (e.g., number of planned SSBs, e.g., including skipped and transmitted SSBs); list of SSBs in Set A for initial access (e.g., list of planned SSBs, e.g., via ssb-SetA); list of Set B for initial access (e.g., list of transmitted or skipped SSBs for initial access, e.g., via ssb-SetB); assistance information for transmitted or skipped SSBs; number of transmitted or skipped SSBs; pattern of transmitted SSBs; beam angle related information; and/or associated SSBs.

In an example, the gNB may indicate one or more of the following based on whether SSB skipping is enabled or not. For example, a flag (e.g., 1 bit) indication (e.g., 0 may indicate not supporting SSB skipping and 1 may indicate supporting SSB skipping) may be supported. Based on the indication, the WTRU may determine a mode of operation for initial access. For example, the WTRU may determine an initial access procedure without SSB skipping if the WTRU receives an indication of not supporting SSB skipping. In an example, the WTRU may determine an initial access procedure with SSB skipping if the WTRU receives an indication of supporting SSB skipping. The WTRU may determine to send an indication that the WTRU wants to use some skipped SSB for or after an initial access procedure. In an example, the indication may be implicitly indicated (e.g., based on number of SSBs for initial access. For example, if an indicated (or determined) number of SSBs for initial access is smaller than (or equal to) a threshold (e.g., 32), the WTRU may determine a first mode of operation (e.g., no SSB skipping). If the indicated (or determined) number of SSBs for initial access is larger than the threshold, the WTRU may determine a second mode of operation (e.g., SSB skipping). In another example, the indication may be implicitly indicated (e.g., based on number of skipped SSBs. For example, if an indicated (or determined) number of skipped SSBs is X (e.g., 0), the WTRU may determine a first mode of operation (e.g., no SSB skipping). Otherwise, the WTRU may determine a second mode of operation (e.g., SSB skipping). The number of skipped SSBs may be determined as: Number of skipped SSBs=Number of SSBs for initial access-number of transmitted SSBs.

In an example, the gNB may indicate one or more of the following based on type of AI/ML model. The WTRU may receive an indication of a type of AI/ML model for initial access. For example, the WTRU may receive a flag indication with a first value (e.g., value zero) that may indicate a first type of AI/ML model and the flag indication with a second value (e.g., value one) that may indicate a second type of AI/ML model. In another example, a flag indication with a first value (e.g., value zero) may indicate no AI/ML model to be used for initial access, the flag indication with a second value (e.g., value one) may indicate a first type of AI/ML model, the flag indication with a third value (e.g., value two) may indicate a second type of AI/ML model, the flag indication with a fourth value (e.g., value three) may indicate a third type of AI/ML model, and so forth.

In an example, the gNB may indicate one or more of the following based on number of SSBs in Set A for initial access (e.g., number of planned SSBs, e.g., including skipped and transmitted SSBs). The WTRU may receive an indication on number of SSBs in Set A for initial access. For example, the WTRU may receive an indication (e.g., two bits, where 0 indicates 16 SSBs, 1 indicates 32 SSBs, 2 indicates 64 SSBs and 3 indicates 128 SSBs). In an example, the WTRU may blindly detect number of SSBs for initial access based on the transmitted SSBs. For instance, if the number of transmitted SSBs is equal to the number of SSBs in Set A, or if the number of transmitted SSBs is a ratio (e.g., half, one-third, one-fourth, etc.) of the number of SSBs in Set A.

In an example, the gNB may indicate one or more of the following based on list of SSBs in Set A for initial access (e.g., list of planned SSBs, e.g., via ssb-SetA). The WTRU may receive an indication on which SSBs are in Set A used for initial access. For example, the WTRU may receive a bitmap of SSBs. If an associated bit of the bitmap with a SSB indicates a first value (e.g., value zero), then the corresponding SSB may not be used for initial access. If the bit indicates a second value (e.g., value one), then the corresponding SSB may be used for initial access. A payload size of the indication may be based on frequency range of a cell for operation. For example, if the frequency range is lower than (or equal to) X1, the payload size may be FO bits (e.g., 4). If the frequency range is higher than X1 and lower than (or equal to) X2, the payload size may be F1 bits (e.g., 8 bits). If the frequency range is higher than X2, the payload size may be F2 bits (e.g., 64 bits). X1, X2, F0, F1 and F2 may be predefined or semi-statistically configured. The indication may be based on an existing field (e.g., in SIB and/or MIB). For example, the field ssb-PositionsInBurst may be used for the indication. For example, if the WTRU receives an indication of a mode of operation and determines a first mode (e.g., not SSB skipping), the WTRU may use ssb-PositionsInBurst for the indication of SSBs in Set A for initial access.

In an example, the gNB may indicate one or more of the following based on list of Set B for initial access (e.g., list of transmitted or skipped SSBs for initial access, e.g., via ssb-SetB). The WTRU may receive an indication on which SSBs are skipped or transmitted. For example, the WTRU may receive a bitmap corresponding to the transmitted or skipped SSBs. If an associated bit of the bitmap with a SSB indicates a first value (e.g., value zero), then the corresponding SSB may not be transmitted. If the bit indicates a second value (e.g., value one), then the corresponding SSB may be transmitted. A payload size of the indication may be based on frequency range of a cell for operation. For example, if the frequency range is lower than (or equal to) X1, the payload size may be FO bits (e.g., 4). If the frequency range is higher than X1 and lower than (or equal to) X2, the payload size may be F1 bits (e.g., 8 bits). If the frequency range is higher than X2, the payload size may be F2 bits (e.g., 64 bits). X1, X2, F0, F1and F2 may be predefined or semi-statistically configured. The indication may be based on an existing field (e.g., in SIB and/or MIB). For example, the field ssb-PositionsInBurst may be used for the indication. For example, if the WTRU receives an indication of a mode of operation and determines a second mode (e.g., SSB skipping), the WTRU may use ssb-PositionsInBurst for the indication of Set B, that is the transmitted or skipped SSBs.

In an example, the gNB may indicate one or more of the following based on assistance information for transmitted or skipped SSBs. The WTRU may determine the association between one or more beam IDs and SSBs. The association may be based on the beam information configured by a gNB and/or reported by the WTRU. The association may be based one or more of: explicit indication; order of beam direction; and/or order of a panel and/or TRP (CORESET group ID).

For example, the association between one or more beam IDs and SSBs may be based on explicit indication. The WTRU may receive an explicit indication (e.g., based on a configuration of beam information) of beam ID for each SSB. For example, the WTRU may be configured with one or more beam IDs and each beam ID may comprise one or more beam information (e.g., beam direction, beam width, panel and/or TRP ID, etc.) For example, the association between one or more beam IDs and SSBs may be based on order of beam direction. A beam ID may be associated with a SSB based on a direction of the SSB. For example, a first beam ID may be associated with a SSB with a beam direction with a lowest and/or highest angle (e.g., 5 degrees) and a second beam ID may be associated with a SSB with a beam direction with a second lowest and/or highest angle, etc.

For example, the association between one or more beam IDs and SSBs may be based on order of a panel and/or TRP (CORESET group ID). A beam ID may be associated with an order of a panel and/or TRP which comprises a SSB. For example, a first beam ID may be associated with a SSB with a first panel and/or TRP and a second beam ID may be associated with a SSB with a second panel and/or TRP, etc.

The WTRU may receive an indication on number of transmitted or skipped SSBs. For example, the WTRU may receive an indication (e.g., 2-bit indication, e.g., 0 indicates 8 SSBs, 1 indicates 16 SSBs, 2 indicates 32 SSBs and 3 indicates 64 SSBs). A payload size of the indication may be determined based on the number of transmitted or skipped SSBs for initial access. For example, the payload size may be N1 bits (e.g., 1 bit) if the total number of transmitted or skipped SSBs is smaller than (or equal to) Y. The payload size may be N2 bits (e.g., 2 bits) if the total number of transmitted or skipped SSBs is larger than Y. In an example, the WTRU may blindly detect number of skipped SSBs for initial access based on the number of transmitted SSBs.

In an example, the WTRU may be implicitly indicated the number of transmitted or skipped SSBs based on a pattern of transmitted SSBs. For example, if the pattern is a first pattern, then the WTRU may determine a first number of transmitted or skipped SSBs. If the pattern is a second pattern, then the WTRU may determine a second number of transmitted or skipped SSBs.

In an example, the WTRU may be implicitly indicated a number of transmitted or skipped SSBs based on a supported AI/ML model for initial access and/or beam prediction. For example, if the AI/ML model is a first AI/ML model, then the WTRU may determine a first number of transmitted or skipped SSBs. If the AI/ML model is a second AI/ML model, then the WTRU may determine a second number of transmitted or skipped SSBs.

The WTRU may receive an indication on a pattern of transmitted SSBs. For example, the WTRU may receive an indication (e.g., 2- bits indication, e.g., 0 indicates pattern #1, 1 indicates pattern #2, 2 indicates pattern #3 and 3 indicates pattern #4). The patterns for the indication may be predetermined or semi-statically configured. A payload size of the indication may be determined based on the number of total planned (Set A), transmitted (Set B), and/or skipped SSBs. For example, the payload size may be N3 bits (e.g., 1 bit) if the total, transmitted, and/or skipped number of SSBs is smaller than (or equal to) Z. The payload size may be N4 bits (e.g., 2 bits) if the total planned, transmitted, and/or skipped number of SSBs is larger than Y.

The WTRU may receive one or more of the following information associated with transmitted and/or skipped SSBs. The WTRU may receive an indication of coverage of each of the SSBs for initial access (e.g., angular coverage such as 120 degrees). The WTRU may receive an indication of coverage of transmitted SSBs (e.g., angular coverage such as 120 degrees). The WTRU may receive an indication of coverage of skipped SSBs (e.g., angular coverage such as 60 degrees). The WTRU may receive an indication of a position, Center, and/or Direction of transmitted SSBs (e.g., 0 degree). The WTRU may receive an indication of a position, Center, and/or Direction of skipped SSBs (e.g., 0 degree).

The WTRU may receive in indication of a granularity of transmitted SSBs (e.g., 3 degrees). For example, the WTRU may receive one configuration for each of horizontal and/or vertical domains. For example, the WTRU may indicate one configuration (e.g., via WTRU capability) for each of horizontal and/or vertical domains. For example, the WTRU may receive granularity of skipped SSBs (e.g., 12 degrees). For example, the WTRU may receive one configuration for each of horizontal and/or vertical domains. For example, the WTRU may indicate one configuration (e.g., via WTRU capability) for each of horizontal and/or vertical domains.

For some information, an indication may be per direction (e.g., horizontal angle (or azimuth angle), vertical angle (or elevation angle), boresight angle, etc.). For some information, an indication may be per WTRU and may be applied to each applicable direction.

The WTRU may receive configuration information for at least one of the detected SSB beams (e.g., via SIB). In an example, the information may include a list of candidate skipped SSB beams (ssb-candidate) that are associated with the corresponding detected SSB beams. In an example, the association may include the beams that are neighbor, adjacent, and/or correlated with a detected beam from the list of transmitted beams (ssb-SetB). The configuration information on the candidate skipped beams may include the beam indexes, azimuth angle, elevation angle, boresight angle, and so forth. In an example, the WTRU may use the configured list of candidate skipped beams to down select and/or determine the potential candidates for the prediction of the best SSB beams.

The WTRU may determine which SSB beams are associated (e.g., neighbor, adjacent, or correlated) with the detected beam (e.g., from ssb-SetB), based on the configured list of candidate SSB beams (e.g., vis ssb-candidate in SIB). For example, a skipped SSB may be associated with transmitted SSBs which have neighboring beam IDs (e.g., a skipped SSB with beam ID X may be associated with SSB with beam ID X+d1 and/or X−d2) or neighboring orders in the list (e.g., X-th SSB may be associated with X+d1th SSB and X-d2th SSB).

The WTRU may determine k best (e.g., predicted) SSB beams (e.g., based on highest quality of RSRP, RSRQ, hypothetical BLER, and so forth) based on the one or more information in the above. For example, the WTRU may use the list of predicted beams along with the received list of candidate SSB beams (e.g., ssb-candidate) to select k best SSB beams. The k best SSB beams in the list may be ordered (e.g., based on the descending order of RSRP, RSRQ, etc.) for the predicted SSB beams according to the AIML model. The set of predicted SSBs may be sorted in a descending order of reference signal received power (RSRP) and a predicted SSB is selected from the sorted list.

Based on the determined k best SSB beams, the WTRU may initiate initial access (e.g., by sending the PRACH preamble) on the PRACH resources (e.g., starting with the SSB beam that is ordered the first best beam in the list of k best SSB beams). In case the WTRU uses PRACH preamble of PRACH resources corresponding to the predicted SSB, the WTRU may receive, be provided, and/or configured with one or more information configurations on one or more SSB-specific (e.g., beam-specific) parameters. The WTRU may receive the configurations as part of initial access procedure (e.g., via RAR, Msg4, and/or MsgB). As an example, the SSB-beam-specific parameter may be the information on paging search space for the predicted SSB, where the WTRU may receive and index to a list or table indicating corresponding time and frequency resources. In an example, the gNB determines to send the configurations for the WTRU, as the gNB may determine that the WTRU has predicted the predicted SSB based on received PRACH, since the corresponding SSB was not transmitted in the first place.

In an embodiment, PRACH preamble may be transmitted in AIML scenarios with skipped SSBs. In an example solution, a WTRU may perform one or more of the following. A WTRU may be configured with a set of transmitted SSB beams and a set of predicted SSB beams. The WTRU may select a predicted beam for which it performs initial access (e.g., based on predicted RSRP)

A WTRU may initiate initial access by sending or transmitting the PRACH or random access preamble on or using the PRACH/random access resources, where the PRACH resources may be selected based on one or more of the following: An associated detected SSB beam Predicted SSB beams; and/or a Combination of multiple detected and/or predicted SSB beams.

In an example, PRACH resources may be selected based on an associated detected SSB beam. For example, the WTRU may be configured to transmit the random access preamble or PRACH preamble on the resources corresponding to an associated detected SSB beam or actually transmitted SSB. The WTRU may indicate the preferred predicted beam to the gNB as a function of PRACH preamble selection or Msg3 transmission, or in a transmission performed after RA procedure. An indication sent in a random access message three may be indicative of a skipped SSB. For example, the gNB may indicate whether the predicted beam is accepted (e.g., by sending the same RAPID (Preamble ID) or another ID to indicate to WTRU to select another beam (e.g., detected beam or predicted beam).

For example, this may be beneficial if the gNB didn't send an SSB due to gNB implementation (e.g., gNB turns off those beams for power consumption enhancement). The gNB may not want to receive anything at those beams as well. The gNB may not use that beam unless a WTRU asks for it.

In an example, PRACH resources may be selected based on predicted SSB beams. For example, the WTRU may be configured to transmit the PRACH preamble on the resources corresponding to one of the predicted SSB beams (e.g., the one with the highest RSRP). The random access preamble or random access resources may be indicative of a skipped SSB. The WTRU may be configured or determines to use one or more Random Access parameters (e.g., for the PRACH transmission and RAR reception (e.g., number of retransmissions of PRACH preamble, power ramp-up value, and so forth)).

In an example, PRACH resources may be selected based on a combination of multiple detected and/or predicted SSB beams. For example, the WTRU may be configured to transmit the PRACH preamble on multiple resources (e.g., based on the configurations received for the detected SSB, (e.g., in the direction of the detected SSB)) corresponding to the detection and/or prediction of more than one SSB beam (e.g., the first resource may indicate that the detected SSB and a first predicted SSB beam are both preferred beams; the second resource may indicate that the detected SSB and a second predicted SSB beams are preferred beams, and so forth). As an example, in case the gNB receives a PRACH on the resources corresponding to an SSB beam that was not actually transmitted, the gNB may expect that the SSB was selected based on the prediction.

The WTRU may monitor the PDCCH scrambled with RA-RNTI to detect RAR within the period RAR-Window corresponding to the transmitted PRACH and/or associated detected and/or predicted SSB beams. In an example, if the WTRU receives a RAR or a downlink transmission, the WTRU may continue with initial access (e.g., transmission of Msg3, etc.). The WTRU may receive the downlink transmission using a beam associated with the skipped SSB.

Herein, initial access and random access (RA) may be used interchangeably to refer to the one or more procedures associated with establishing connectivity between the WTRU and network. The random-access procedure may be triggered by a number of events, for example: initial access from RRC IDLE; RRC connection re-establishment procedure; DL or UL data arrival during RRC_CONNECTED when UL synchronization status is “non-synchronized”; UL data arrival during RRC_CONNECTED when there are no PUCCH resources for scheduling request (SR) available; SR failure; request by RRC upon synchronous reconfiguration (e.g., handover); RRC connection resume procedure from RRC_INACTIVE; to establish time alignment for a secondary TAG; beam failure recovery; and/or consistent UL LBT failure on SpCell.

The WTRU may be configured to perform one or more types of initial access, for example: CBRA with 4-step RA; CBRA with 2-step RA; CFRA with 4-step RA; and/or CFRA with 2-step RA.

In an embodiment, random access resources may be used. The WTRU may receive, identify, or be configured the time domain resource allocations for the consecutive random-access occasions (RO) based on the higher-layer parameter prach-ConfigurationIndex, or by msgA-PRACH-ConfigurationIndex if configured. These parameters may denote the PRACH configuration index corresponding to tables that include random access parameters.

In an example, one or more of the following parameters may be derived from the table. For example, preamble format may refer to one of the possible formats, namely: A1, A2, A3, B1, A1/B1, A2/B2, A3/B3, B4, C0, C2. The preamble format may identify the corresponding Cyclic Prefix (CP) duration, sequence part duration, and guard time duration (if applicable). Frame number and slot number may indicate the frames that may be used for the PRACH transmission and the PRACH slot within the corresponding frame. Starting symbol may determine the symbol-level index corresponding to the starting position of the first RO transmission within the PRACH slot. A number of PRACH slots within a 60 kHz slot may define the number of PRACH slots within the reference PRACH slot, e.g., for higher SCS such as 120 kHz, 480 kHz, 960 kHz, considering the 60 kHz PRACH slot as the reference slot. A number of time-domain PRACH occasions within a PRACH slot (Nₜ^{RA, slot}) may define the number of consecutive ROs that are located within a PRACH slot in time domain. PRACH duration may correspond to the preamble format implying the number of sequence part within an RO.

The WTRU may receive the frequency domain resource allocations for the ROs based on one or more of the following higher-layer parameters: msg1-FrequencyStart or msgA-RO-FrequencyStart; and/or msg1-FDM or msgA-RO-FDM. The msg1-FrequencyStart or msgA-RO-FrequencyStart, if configured, may indicate the offset of the lowest PRACH transmission occasion in frequency domain with respect to the PRB 0. The msg 1-FDM or msgA-RO-FDM, if configured, may indicate the number of PRACH transmission occasions that are FDMed in one time-domain RO. For example, the WTRU may receive, identify, or be configured the number of ROs in frequency domain (M) per each time-domain PRACH occasion based on the higher parameter msg1-FDM, msg1-FDM-16, or msgA-RO-FDM if configured, msg1-FDM={one, two, four, eight}. For example, the WTRU may number the PRACH frequency resources n_{RA}={0, 1, . . . , M-1}, starting from the lowest frequency, in increasing order in the initial uplink BWP during the initial access or the active uplink BWP otherwise.

The WTRU may receive the association and mapping between the SS/PBCH block indexes and PRACH transmission occasions based on higher layer parameter ssb-perRACH-OccasionAndCB-PreamblesPerSSB={⅛, ¼, ½, 1, 2, 4, 8, 16}. The parameter may indicate the number of SS/PBCH block indexes associated with a PRACH transmission occasion in addition to the number of preambles per SS/PBCH block index per PRACH occasion. The WTRU may perform PRACH transmission in respective random-access resources and according to spatial relation with an associated SS/PBCH block.

In example embodiments, contention-based PRACH preambles and/or contention-free PRACH preambles may be used. In an example, the same set of preambles as described above may be configured for each SSB such that multiple WTRUs may have access to the same preamble, making the initial access procedure similar to a contention-based scenario. In an example, these preambles may refer to legacy preambles that convey information on the SSB beam (detected, skipped and/or predicted SSB) selected by the WTRU. In an example, these preambles may convey additional information, either implicitly or explicitly as described above. In the event that one preamble is selected by more than one WTRU, the WTRU may receive from the network (e.g., in the RAR message or Msg4 or MsgB), an indication that either the preamble is taken or to select another preamble. The WTRU may interpret non-reception of preamble ID in a response from the network (e.g., in Msg4 or MsgB) within a preconfigured time window as an indication that the preamble is taken by another WTRU. The WTRU may then select another preamble in a similar way to contention-based initial access. If contention resolution is not successful after Msg 3 (re)transmission(s), the WTRU may go back to Msg 1 transmission. In case of no contention, the WTRU may receive from the network (in RAR, Msg 4, or MsgB) a confirmation that the preamble is accepted, e.g., through reception of the same Random Access Preamble ID (RAPID). The WTRU may then send Msg3 using the UL grant scheduled in the response.

In an example, the preamble may be a dedicated preamble designated by the network in a contention-free manner. For example, one or more preambles may be ‘reserved’by the network for a WTRU or group of WTRUS. The contention-free preambles may correspond to the same or to a different set of resources (e.g., RACH Occasions in the time domain, PRACH Occasions in the frequency domain, SSBs corresponding to one or multiple beams in the spatial domain) to the contention-based preambles. These preambles may correspond to any transmitted, skipped, or predicted SSB.

The MsgA of a 2-step initial access procedure may include a contention-free preamble on PRACH and a payload on PUSCH. After MsgA transmission, the WTRU may monitor for a response from the network within a preconfigured window. In this case as well, the PRACH preamble used by the WTRU may correspond to transmitted/associated or predicted SSB. The dedicated preamble and PUSCH resource are configured for MsgA transmission and upon receiving the network response, the WTRU ends the initial access procedure.

In embodiments, PRACH resources may be selected for a predicted beam. The WTRU may detect a first SSB beam (e.g., during initial access). The WTRU may predict and/or determine one or more predicted SSBs (e.g., based on AIML systems) from a list of the skipped SSB beams that are not transmitted or preferred predicted SSBs. The WTRU may select a best predicted SSB and initiate the initial access procedure accordingly (e.g., PRACH preamble transmission).

In an example, (e.g., alternatively) the WTRU may be configured (e.g., by the network) with information on the association between two or more SSB beams, for example, the WTRU may receive a mapping table from the network indicating association between two or more transmitted and/or skipped SSB beams based on spatial correlation (e.g., adjacent or neighbor beams) or on beam parameters (e.g., two beams at a particular elevation angle or with RSRP above a threshold may be associated).

In an example, the association between one or more transmitted and/or skipped SSBs may be configured by the network and indicated to the WTRU in terms of beam indices. In an example, the association may apply in one or more cases, for example, the WTRU may be configured to apply the association if one or more conditions are met (e.g., if at cell edge, use association, otherwise use (e.g., legacy) detected beam).

A WTRU may determine the PRACH resources for the transmission of a selected, configured, and/or determined PRACH preamble. One or more of the following may apply: PRACH resources for a detected SSB based on detected SSB beam; PRACH resources for a predicted SSB based on associated detected SSB beam; PRACH resources for a predicted SSB based on predicted SSB beam; and/or PRACH resources based on a combination of multiple detected and/or predicted SSB beams.

The WTRU may select PRACH resources based on detected SSB beams for initial access (e.g., when the WTRU performs initial access for the first time when joining a new cell or when the WTRU performs initial access after a long time of inactivity). During the session, the WTRU may receive (e.g., from the gNB) configurations to use associated detected SSB beams and/or predicted SSB beams such that for future instances of initial access, the WTRU may select PRACH resources based on associated detected SSB beams or predicted SSB beams.

In an embodiment, the WTRU may determine or be configured to perform PRACH preamble transmission based on the PRACH resources corresponding to the associated detected SSB beam. The WTRU may indicate the preferred predicted SSB beam (e.g., to the gNB) based on the WTRU selection of the PRACH preamble. In an example, in case the WTRU has predicted the best predicted beam to be a first (e.g., associated and/or candidate) skipped beam, the WTRU may select and transmit the PRACH preamble from a first set of preambles; in case the WTRU has predicted the best predicted beam to be a second (e.g., associated and/or candidate) skipped beam, the WTRU may select and transmit the PRACH preamble from a second set of preambles; and so forth. In an example, (e.g., alternatively) the WTRU may indicate the preferred predicted SSB beam (e.g., to the gNB) as part of initial access signaling (e.g., Msg3 and/or MsgB transmission). The WTRU may (e.g., otherwise) indicate the preferred predicted SSB beam (e.g., to the gNB) after switching to Connected-Mode and after connecting to the gNB.

The transmission of PRACH preamble on the resources corresponding to the detected SSB may be useful in case the network has not sent an SSB due to gNB implementation. For example, the gNB may turn off some beams for power consumption enhancements. The gNB may not want to receive any preamble corresponding to these beams or any data transmissions via these beams. The beams may not be activated unless or until a WTRU specifically requests for it (e.g., via selecting and transmitting a preamble corresponding to the preferred predicted beam). The network may not activate the beam, despite the request from the WTRU. For example, the gNB may decide not to activate the WTRU's preferred predicted beam because there may be a (e.g., neighbor and/or adjacent) SSB that is already activated that the gNB determines to be sufficient to meet the data transmission requirements of the WTRU. In such a case, the gNB may send an indication to the WTRU to select the corresponding SSB beam.

Herein, preamble and PRACH preamble may be used interchangeably. In an embodiment, the WTRU may be configured to transmit one or more preambles for one or more associations of the SSBs. For example, the WTRU may indicate the selected, predicted, skipped, and/or detected SSB (e.g., index) based on the selection of a PRACH preamble. For example, a first preamble may be used to indicate a first selected SSB (e.g., from the list of skipped SSBs and/or from the list of transmitted SSBs, from the list of predicted SSBs, and so forth); a second preamble may be used to indicate a second selected SSB, and so forth.

The preamble may be a long sequence preamble or short sequence preamble. The preamble may be a legacy preamble or a new preamble. In a new preamble, additional bits may be added to convey additional information for example. The preamble format selected by the WTRU may depend on scenarios and/or additional information that the WTRU may want to indicate (e.g., to the network). For example, in the case of cell deployments, for example, some preamble formats may be used for large cells, others for small cells, macro cells, etc.). For example, in the case of frequency ranges, some preamble formats may be used in FR1 deployments and other preamble formats in FR2 deployments. In the case of sub carrier spacing, for example, a first preamble format may be used for a first sub-carrier spacing (e.g., 15 or 30 kHz), a second preamble format for a second sub-carrier spacing (e.g., 60 or 120 kHz), and so forth. In the case of information specific to AI/ML beam management, for example, the WTRU may use a first preamble for a first detected SSB, a second preamble for a predicted SSB based on a first associated skipped SSB, a third preamble for a predicted SSB based on a second associated skipped SSB, and so forth.

The WTRU may use the selected preamble to indicate (e.g., to the network) the selected and/or preferred SSB selected by the WTRU. In an example, the WTRU may implicitly indicate additional information based on the selection of PRACH preamble. For example, the WTRU may determine or be configured to use a first set of preambles for a first mode of operation, a second set of preambles for a second mode of operation, and so forth. For example, the WTRU may select a first preamble for a first SSB to indicate that the AI/ML model at the WTRU is using a first type, size, etc. of set B beams for beam prediction; the WTRU may select a second preamble for a first SSB to indicate that the AI/ML model at the WTRU is using a second type, size, etc. of set B beams for beam prediction, and so forth. In an example, the WTRU may select a first preamble for a first SSB to indicate that a first type of AI/ML model (e.g., Recurrent Neural Network (RNN)) is used by the WTRU, the WTRU may select a second preamble for a first SSB to indicate that a second type of AI/ML model (e.g., Deep Neural Network (DNN)) is used at the WTRU, and so forth. In examples, additional bits may be added to the preamble to convey and/or indicate additional information. In more examples, additional information may be encoded with the preamble, (e.g., through scrambling).

In an example, an AI/ML capable WTRU may predict the best beam for a future time instance, e.g., beam with the highest predicted RSRP, based on, for example, parameters such as historical beam ID and their corresponding RSRP, beam angles, associated beams, etc. The WTRU may be configured to transmit PRACH preamble on resources corresponding to one of the (e.g., best) predicted SSB beams (e.g., the one with the highest predicted RSRP based on the output of the AI/ML model).

In an example, the WTRU may receive configuration information on how to generate preambles corresponding to predicted beams in SIB (e.g., an existing SIB or an AI/ML-specific SIB). In an example, the WTRU may be configured with a space (e.g., ID space) by the network where the WTRU may be able to generate preambles corresponding to the predicted SSB beam. In case the gNB receives a PRACH on the resources corresponding to an SSB beam that was not actually transmitted, the gNB may expect that the SSB may be selected, predicted, and/or determined based on the prediction.

In an example, the WTRU may be able to use the same preamble associated with a beam in the present at a future time instant. For example, if a WTRU performs initial access using a detected/transmitted beam (e.g., beam X) at a time T1 to transition to connected state. The WTRU may then go to idle state at time T2. At a time T3, the WTRU may determine to perform initial access at a later time T4 based on a predicted beam. If the WTRU has remained stationary, the AI/ML model may determine the same beam X to be the most suitable beam for the WTRU to use for initial access. As a result, the WTRU may use the same preamble it previously used to perform initial access.

In an embodiment, a WTRU that transmits PRACH preamble on PRACH resources based on a predicted SSB beam may be configured or determine to use one or more different random-access parameters, compared to the (legacy) PRACH preamble transmission on resources based on a detected SSB. In an example, the WTRU may be explicitly configured with the random-access parameter values. In an example, the WTRU may receive differential values and/or offsets to be applied to the configured parameters for the (legacy) PRACH preamble transmission on resources based on a detected SSB. As an instance, the number of retransmissions of PRACH preambles, power ramp-up value, the random-access response time window, and so forth may be different for PRACH preamble transmission on PRACH resources based on a predicted SSB beam compared to (legacy) PRACH preamble transmission on resources based on a detected SSB.

In an example, when the WTRU is configured to use a predicted SSB to perform initial access, the RACH resources, configurations, and/or parameters associated with one or more predicted SSB beams may be configured to remain valid for a longer time duration. Those RACH resources and/or configurations may include any of preambles, sequences, partitions, time and/or frequency resources associated with RACH. RACH resources may also include RACH occasions that the WTRU may use when transmitting RACH preambles. The parameters associated with RACH resources may include the start/stop time, transmission duration, periodicity, Tx power, Tx spatial direction, etc. The RACH resources may be selected by the WTRU from a set which may be common to multiple UEs or dedicated to the WTRU, for example. The common or dedicated RACH resources may be accessed via broadcast channel/beams (e.g., SIB, SSB), via initial access messages (e.g., in Msg 2 or Msg B) or (pre)configured in the WTRU, for example.

In an embodiment, a WTRU may be configured to transmit the PRACH preamble on multiple resources corresponding to the detection and/or prediction of more than one SSB beam. In an example, the WTRU may use the (combination) PRACH resources to indicate that the WTRU prefers a predicted SSB in addition to a detected SSB (e.g., with the highest measured and/or predicted RSRP). The WTRU may use the spatial filter and/or beam direction corresponding to and/or QCL-ed with the detected SSB for the PRACH transmission. For example, the WTRU may use a first set of (combination) PRACH resources the indicate that the detected SSB and a first predicted (and/or skipped) SSB beams are the preferred beams; the WTRU may use a second set of (combination) PRACH resources to indicate that the detected SSB and a second predicted (and/or skipped) SSB beams are the preferred beams, and so forth.

The network may determine the best SSB beam to be used to grant the WTRU for the initial access, for example, based on loading, beam quality (e.g., RSRP), etc. The network may indicate the beam that it selected by using the preamble ID (RAPID) corresponding to that beam (e.g., in RAR message). After transmission of the PRACH preamble on the (combination) PRACH resources, the WTRU may monitor the downlink control channels (e.g., CORESET, PDCCH, etc.) corresponding to each corresponding preferred SSB (e.g., the detected SSB and the first predicted SSB, the detected SSB and the second predicted SSB, and so forth). In an example, the WTRU may detect one or more RAR messages (e.g., RAR PDCCH), where the WTRU may determine the corresponding SSB based on the received RAPID in the RAR message. Any one or more of the solutions as described above for initial access based on detected beams or predicted beams may also apply in this case.

Following the PRACH preamble transmission on a detected, skipped, and/or predicted beam, the WTRU may monitor the PDCCH scrambled with RA-RNTI to detect RAR within the period RAR-Window corresponding to the transmitted PRACH and/or associated detected and/or predicted SSB beams. In case the WTRU receives a RAR (in Msg 2/Msg B), the WTRU may also receive an UL grant contained in the RAR, which may be used to transmit the RRC setup request (e.g., Msg 3). The network may estimate the timing (e.g., propagation delay) based on the preamble received (e.g., in Msg 1/Msg A) and may send the TA value to the WTRU in the RAR message. In response to Msg 3, the WTRU may receive the RRC setup complete message (e.g., Msg 4), which if successful, may transfer the WTRU to connected state. In an embodiment, If the PRACH preamble transmission based on the predicted SSB beam fails (e.g., RAR is not received within the RAR-window period), the WTRU may determine the fallback procedure.

The WTRU may exhibit certain behavior in case of a failed PRACH transmission. In an embodiment, a WTRU may perform one or more of the following. A WTRU may be configured with a set of transmitted SSB beams and a set of predicted SSB beams. The WTRU may select a predicted beam (e.g., based on predicted RSRP), for which it performs initial access (e.g., PRACH preamble transmission). The WTRU may monitor the PDCCH scrambled with RA-RNTI to detect RAR within the period RAR-Window corresponding to the transmitted PRACH and/or associated detected and/or predicted SSB beams. In case the WTRU receives a RAR, the WTRU may continue with initial access (e.g., transmission of Msg3, etc.). If the WTRU does not receive a RAR within a configured time window or based on a counter, the WTRU may perform one or more of the following example methods. In one example method, the WTRU may switch the SSB beam to another SSB beam from the list of predicted SSB beams and so on up to k beams (e.g., selected in the descending order of RSRP). The set of predicted SSBs may be sorted in a descending order of reference signal received power (RSRP) and a predicted SSB is selected from the sorted list. In one example method, the WTRU may transmit PRACH for the detected beam. In one example method, the WTRU may wait for legacy SSB burst with each SSB beam transmitted. For example, the gNB may have SSB bursts with each intended SSB beam (ssb-SetA) transmitted maybe with longer period. For example, after M SSB bursts with skipped SSB beams, the gNB may transmit an SSB burst with each intended beam transmitted. The WTRU may wait for maximum duration of M SSB bursts (e.g., M is configured in MIB or SIB1) and then may detect the best SSB beam accordingly. In one example method, the WTRU may reject this cell and attempt to detect another SSB block in a different sync raster or another cell.

A WTRU may be configured with a set of transmitted SSB beams and a set of predicted SSB beams. In one or more example embodiments herein, the transmitted SSB beams may be associated with Set B or a configuration thereof. In an example embodiment, the WTRU may be configured to predict RSRP of a first beam (e.g., a predicted beam) based on measured RSRP of a second beam (e.g., a transmitted beam). The terms predicted beam and skipped beam may be used interchangeably. The term transmitted beam, Set B beam, measured beam may be used interchangeably. The term beam may refer to SSB beam, CSI-RS beam, or both.

In an example embodiment, the WTRU may be configured with parameters for random access procedure corresponding to skipped beams wherein one or more of the parameters may be configured specifically for preamble transmissions associated with predicted beams. For example, the WTRU may be configured with maximum number of random-access preamble transmission associated with each predicted beam and/or collectively for each predicted beam. Possibly different values for max number of retransmissions may be configured for predicted beams and detected beams. Possibly different values for ra-ResponseWindow may be configured for predicted beams and detected beams.

In an embodiment, an RA preamble transmission may be performed that is associated with skipped SSBs. The WTRU may be configured to predict one or more parameters (e.g., RSRP) of one or more SSB beams (e.g., predicted SSB beams) based on one or more parameters (e.g., RSRP) of one or more of the measured SSB beams (e.g., transmitted SSB beams). The WTRU may be configured to select a best beam for preamble transmission, wherein the best beam may be a predicted beam or a detected beam. In a first solution, if the difference between one or more predicted parameters and one or more measured parameters (e.g., RSRP) is higher that a (pre)configured threshold, the WTRU may select detected beam for PRACH preamble transmission. Otherwise, the WTRU may select the predicted beam for PRACH preamble transmission. The WTRU may determine the parameters to apply for random access procedure based on the type of beam wherein the type of beam may refer to transmitted SSB beam, predicted SSB beam, and so forth.

In an example embodiment, the WTRU may be configured with a first ra-ResponseWindow (e.g., random-access response time window) value and a second ra-ResponseWindow value. The WTRU may apply the first ra-ResponseWindow value if the preamble transmission is associated with detected SSB beam. The WTRU may apply the second ra-ResponseWindow value if the preamble transmission is associated with predicted SSB beam. The WTRU may be configured with different set of retransmission count, power ramping parameters based on the type of beam selected for random access procedure. Upon transmission of preamble, the WTRU may monitor for PDCCH scrambled with RA-RNTI to detect RAR within the ra-Response Window corresponding to the transmitted PRACH and/or associated detected and/or predicted SSB beams. In case the WTRU receives a RAR, the WTRU may continue with initial access (e.g., transmission of Msg3, etc.). The WTRU may exhibit certain behavior in case of failed preamble transmission on predicted beams. In an example embodiment, a WTRU may be configured to handle a preamble transmission failure as a function of type of beam associated with preamble transmission. Herein, the type of beam may refer to transmission status of beam (e.g., transmitted and/or measured beam, not transmitted, e.g., predicted beam, etc.). For example, upon transmission of preamble associated with predicted beam, if the WTRU did not receive Random Access Response (RAR) before ra-ResponseWindow expiry, the WTRU may consider that the RAR reception is not successful (e.g., a RAR failure associated with predicted beam). In an example embodiment, the WTRU may be configured to maintain preamble transmission counter specific to preamble transmission associated with predicted beams or predicted SSB. In an example embodiment, the WTRU may be configured to increment the counter associated with predicted beams upon unsuccessful RAR reception.

The WTRU may exhibit certain behavior based on predicted beam specific maximum transmission. Upon RAR failure associated with predicted beam, the WTRU may be configured to perform preamble retransmission on that predicted beam. The WTRU may be configured to perform retransmission on the same predicted beam for a max number of retransmissions. In an example embodiment, the maximum number of retransmissions may be configured specific to each predicted beam. In an example, the maximum number of retransmissions may be configured to be greater than or equal to 1. Upon reaching the max number of retransmissions on a specific predicted beam, the WTRU may be configured to switch to a next best predicted beam. For example, the next best predicted beam may be determined based on descending order of RSRP. The set of predicted SSBs may be sorted in a descending order of reference signal received power (RSRP) and a predicted SSB is selected from the sorted list. In an example embodiment, upon reaching the maximum number of retransmissions on a specific predicted beam, the WTRU may be configured to switch to a next best detected beam. In an example embodiment, upon reaching the maximum number of retransmissions on a specific predicted beam, the WTRU may be configured to switch to a next best beam irrespective of whether the beam is predicted or measured beam.

The WTRU may exhibit certain behavior based on cumulative maximum retransmissions across all predicted beams. In an example embodiment, the WTRU may be configured with a first maximum number of retransmissions and a second max number of retransmissions wherein the first maximum number of retransmissions may be associated with each predicted beam and second maximum number of retransmissions may be associated with a cumulative retransmission attempts across each predicted beam. The first maximum number of retransmission value may be smaller or equal to the second maximum number of retransmissions. In an example embodiment, upon reaching the second maximum number of retransmissions, the WTRU may be configured to switch to a next best detected beam. In an example embodiment, the WTRU may be configured with switch a maximum number of predicted beams during the random-access procedure. Herein, the maximum number of predicted beams may be preconfigured. Upon switching maximum number of predicted beams, the WTRU may be configured to switch to a next detected beam. In an example embodiment, the WTRU may be configured with maximum number of retransmissions across multiple (e.g., each) predicted beams.

In an embodiment, the WTRU may determine predicted beam specific retransmission based on confidence level. The WTRU may be configured with (pre)configured rules to determine the max number of retransmissions for each predicted beam. For example, given maximum number of retransmissions across each predicted beam, the WTRU may determine max retransmission attempt for each predicted beam based on confidence of prediction. For example, the WTRU may retransmit N1 times on a first predicted beam with a confidence level C1 and may retransmit N2 times on a second beam with confidence level C2, wherein N1>N2 if C1>C2.

The WTRU may wait for a legacy SSB burst with all SSB beams transmitted. In an example embodiment, if RAR failure associated with predicted beam(s) exceeds a preconfigured number of times, the WTRU may be configured to perform random access procedure based on legacy SSB burst with each SSB beam transmitted.

Herein the RAR failure may be triggered based on one or more of the following conditions: when max retransmissions associated with predicted beam is exceeded, when max cumulative retransmissions associated with each predicted beam is exceeded, when retransmissions on max number of predicted beams as exceeded etc. The WTRU may be configured to suspend the ongoing random-access procedure and wait for legacy SSB burst transmission. For example, the WTRU may be configured with legacy SSB beams via ssb-PositionsInBurst configuration (e.g., in SIB1). The WTRU may be configured with longer periodicity for legacy SSB beams and a shorter periodicity for SSB bursts with Set B beams. For example, after M SSB bursts with skipped SSB beams, the WTRU may be configured to receive SSB burst with legacy SSB beams. The WTRU may be configured with value of M based in MIB or SIB1. For example, upon RAR failure associated with predicted beams, the WTRU may be configured to perform random access procedure based on reception of legacy SSB beams.

The WTRU may reject the cell and trigger initial access on a different cell. In an example embodiment, upon RAR failure associated with predicted beam(s) exceeds a preconfigured number of times, the WTRU may be configured to perform one or more of the following actions. For example, the WTRU may abort the ongoing random-Access Procedure. The WTRU may indicate a random-access problem to higher layers. Based on determining that the RAR was not successfully received during the random access response window and a number of the retransmissions for the first predicted SSB or the second predicted SSB exceeds the max number of the retransmissions, the WTRU may be further configured to indicate a random access problem to a higher layer. The WTRU may bar initial access in this cell for a preconfigured amount of time (e.g., until a (pre)configured timer elapses). The WTRU may trigger initial access on a different cell. (e.g., the WTRU may attempt detection of SSB block in a cell on the same frequency (intra-frequency) or different frequency (inter-frequency), different sync raster, etc.).

In embodiments, correction and confirmation procedures may be performed for the predicted beam based on received RAR. In this embodiment, the terms “skipped SSBs” and “beams not actually transmitted” are used interchangeably. In an example embodiment, the WTRU may perform one or more of the following. The WTRU may determine or select a predicted SSB beam is the best beam (e.g., based on predicted RSRP) based on detected and/or received SSB beams and an AIML model. The detected SSB beams are actually transmitted SSBs and the predicted SSB beams are SSBs not currently being transmitted by a base station. The WTRU received indication of both the actually transmitted SSBs and the predicted SSBs. The WTRU may start initial access procedure by sending PRACH preamble for the predicted SSB beam (e.g., in time and freq, resources associated with the predicted SSB beam) or transmitting a random access preamble using random access resources. The random access preamble or the random access resources are associated with the predicted SSB. The WTRU may monitor to receive RAR in the RAR window.

After receiving RAR (e.g., RAR PDCCH and/or RAR PDSCH on a beam QCL-ed with the predicted SSB beam), the WTRU may measure the RSRP (e.g., based on reference signal in RAR message, e.g., DMRS). The RAR may be received via a beam associated with the predicted SSB. The measured RSRP may be associated with the RAR received. The WTRU may compare the measured RSRP based on received RAR with the predicted RSRP for the predicted SSB, or determine a difference between predicted RSRP for predicted SSB and measured RSRP for predicted SSB. The predicted SSB is based on a predicted RSRP of predicted SSBs. The WTRU may be configured with or receive (e.g., via MIB, SIB1, and/or RAR) one or more parameters regarding offsets and/or thresholds for comparing the RSRP measured based on RAR (e.g., PDCCH DMRS, or PDSCH DMRS) with the RSRP predicted for SSB. For example, the RSRP measured from SSB and DMRS may be different. Also, the transmission power for SSB and DMRS may have a (e.g. large) difference. Therefore, the gNB may provide the offset/threshold (e.g., 10 dB) to compare the values. The WTRU may verify whether or not the prediction was accurate based on the comparison and one or more of the offsets or thresholds (e.g., determine whether or not the difference between the predicted RSRP and measured RSRP is lower than a threshold (e.g., 10dB)). In case the difference between the predicted RSRP with the measured RSRP is lower or less than a (pre)configured threshold, the WTRU may determine that the predicted beam is accurate enough and may continue using the predicted beam for transmission of further signals (e.g., Msg3) by sending an indication of a request to continue to use the beam associated with the predicted SSB for subsequent communication. In case the difference between the predicted RSRP with the measured RSRP is higher or greater than a (pre)configured threshold, the WTRU may determine that the predicted beam is not accurate enough. The WTRU may reject the predicted beam and may continue with selecting another beam or follows procedures considered for failed PRACH transmission by selecting a new predicted SSB and perform a new initial access procedure associated with a beam corresponding to the new predicted SSB. In an example, (e.g., alternatively), in case the WTRU has sent the PRACH based on combination of multiple (e.g., two) detected and/or predicted SSB beams, the WTRU may receive multiple (e.g., two) RAR messages for the corresponding beams. The WTRU may measure the RSRP for each of the received RAR messages and may determine the best beam (e.g., with higher RSRP). The WTRU may transmit the further signals (e.g., Msg 3) based on the selected best beam.

A WTRU may detect one or more SS/PBCH blocks (SSB) from one or more cells (e.g., during initial access, cell search, and/or cell (re)selection), where the cells may be candidate cells used for initial access and/or cell (re)selection. The WTRU may determine, indicate, and/or select at least one of the detected SSBs from at least one of the detected and/or candidate cells as the best SSB (e.g., with the highest measured and/or calculated received power (e.g., RSRP), lowest measured and/or calculated interference, and so forth). In an example, the WTRU may detect, decode, receive one or more information parameters regarding whether skipped SSBs is enabled in the detected cell (e.g., via MIB or SIB1). In an example, the WTRU may receive one or more information parameters regarding, the list of Set A for the planned SSBs (e.g., ssb-SetA), the list of transmitted SSBs (e.g., ssb-SetA), and/or the list of skipped or not transmitted SSBs.

In an example, the WTRU may be configured with or determine a first type SSB beams (e.g., transmitted SSB beams), a second type SSB beams (e.g., predicted SSB beams), and so forth. The WTRU may detect one or more transmitted SSB beams and measure the beam quality (e.g., RSRP). The WTRU may use the measured beam quality for the detected transmitted SSB beams to predict the beam quality (e.g., predicted RSRP) of predicted SSB beams (e.g., by using an AI/ML model). The WTRU may use the SSB beams from different types (transmitted, predicted, etc.), to perform initial access, cell (re)selection, and so forth. For example, the WTRU may select one or more SSB beams based on beam quality (e.g., the beams with the highest RSRPs) for initial access. The WTRU may use the measured beam quality (e.g., RSRP) of the received SSB beams and/or predicted beam quality (e.g., predicted RSRPs) of the predicted SSB beams.

In an example, the WTRU may determine to send a PRACH preamble to the detected cell, where the WTRU may determine the time and frequency resources to transmit the PRACH in association with the predicted SSB beam. After PRACH preamble transmission, the WTRU may monitor and attempt to detect the random-access response (RAR) message (e.g., DCI with CRC scrambled with RA-RNTI) within the period of an RAR-window or limit. In an example, in case the WTRU determines to use the 4-step random access (RA) procedure, the WTRU may transmit a configured, selected, and/or determined PRACH preamble to the cell. After sending the PRACH preamble, the WTRU may monitor for a DL message (e.g., PDCCH and/or PDSCH) (e.g., indicating a RAR message) that may provide an UL grant. The WTRU may send an UL message or indication (e.g., in a PUSCH) based on the UL grant. In an example, in case the WTRU determines to use the 2-step RA, the WTRU may transmit a MsgA that may include a configured, selected, and/or determined PRACH preamble, and a PUSCH carrying a message to the cell. After sending MsgA, the WTRU may monitor for a DL message (e.g., PDCCH) (e.g., indicating a MsgB) that may include (e.g., at least) an RAR and may include contention resolution information.

The WTRU (e.g., an AIML-capable UE) may select a cell (e.g., as the suitable cell) to camp on (e.g., during initial access and/or cell (re)selection procedure). In an example, the WTRU may select the cell based on one or more measured parameters (e.g., measured, evaluated, and/or predicted RSRP, RSRQ), the cell ranking configurations, the measured and/or evaluated interference, and so forth. The WTRU may select a predicted SSB 41 (e.g., SSB beam) as the best SSB in the cell. The WTRU may transmit a PRACH preamble to the selected cell, that is associated to the selected predicted SSB. The WTRU may indicate its determined or selected active mode of operation (e.g., AIML operation) via sending PRACH for example (e.g., via sending PRACH on AIML RO time and frequency resources and/or via using the PRACH preamble selected from a first set that indicates that the WTRU supports AIML, e.g., as described herein).

Beam quality parameters may be measured based on received RAR message(s). In an example embodiment, a WTRU (e.g., that has transmitted PRACH preamble based on a predicted SSB) may measure one or more beam quality parameters (e.g., RSRP, RSRQ, SINR, probability of LOS, etc.) based on the one or more reference signals received in a RAR message (e.g., RAR is received via a beam QCL-ed with the selected predicted SSB beam) (e.g., via RAR PDCCH DMRS, RAR PDSCH DMRS, and so forth). In an example, the WTRU may determine or be configured to compare the measured parameters with the corresponding predicted parameters. The WTRU may need to (re)evaluate the measured parameters in order to scale the parameters so that the WTRU be able to compare the measured parameters with the predicted ones. The WTRU may receive, determine, be provided, or (pre)configured (e.g., via MIB, SIB, etc.) with one or more scaling rules and/or parameters (e.g., offset values, scaling values, thresholds, and so forth).

The (re)evaluation and/or scaling of the measured parameters may be useful, as for example, the RSRP measured from SSB and DMRS may be in different scales, for example due to different frequency BWPs and/or ranges for the RS in SSB and DMRS, different transmission power for SSB and DMRS, and so forth. The WTRU may determine or be configured to use one or more scaling rules (e.g., add, subtract, multiply, or divide one or more scaling values) to be able to compare the values. One or more of the following may apply: RSRP, RSSI, RSRQ;

SINR; probability of LOS; and the like. For example, when RSRP, RSSI, RSRQ applies, the WTRU may receive one or more scaling rules and scaling parameters, to add, subtract, multiply, divide, and so forth with the corresponding measured parameters (e.g., including received signal power, received signal strength, and so forth). For example, when SINR applies, the WTRU may receive one or more scaling rules and scaling parameters, to add, subtract, multiply, divide, and so forth with the measured SINR parameters (e.g., including received signal power, received interference power, received signal strength, received interference strength, and so forth). For example, when probability of LOS applies, the WTRU may receive one or more scaling rules to be applied (e.g., add, subtract, multiply, divide) to the measured probability of LOS for the receives RS along with RAR PDCCH and/or PDSCH signals.

There may be additional parameters, which may include offset between the beam quality (e.g., RSRP) estimated using RSs associated with RAR and the SSB beams. For example, after receiving the RAR (e.g., RAR PDCCH and/or RAR PDSCH on a beam QCL-ed with the selected prediction SSB beam), the WTRU may estimate the RSRP of the selected prediction SSB beam by measuring the beam RSRP of one or more RSs in the RAR message (e.g., DMRS of RAR PDCCH and/or RSR PDSCH) and adding an offset configured or indicated by the gNB.

The verification of the accuracy of predictions may be performed based on RAR message(s). In an embodiment, the WTRU may determine and/or verify whether or not the prediction was accurate based on comparison of the measured parameters from RAR with the predicted parameters for the predicted SSB along with one or more offset values and/or thresholds. The WTRU may receive, determine, be provided, and/or be (pre)configured (e.g., via MIB, SIB, etc.) with one or more threshold values in order to compare the measured parameters with the corresponding predicted parameters. In an example, the WTRU may determine that the difference between one or more of the predicted parameters compared to corresponding (re)evaluated and/or scaled parameters that are based on the measured parameters from the RAR message (e.g., PDCCH and/or PDSCH) is lower than corresponding thresholds. The WTRU may determine that the accuracy level for the predicted SSB is acceptable and may determine to continue with initial access procedures (e.g., transmission of the Msg3).

In an example, (e.g., otherwise) the WTRU may determine that the difference between one or more of the predicted parameters compared to corresponding (re)evaluated and/or scaled parameters that are based on the measured parameters from the RAR message (e.g., PDCCH and/or PDSCH) is higher than corresponding thresholds. The WTRU may determine that the accuracy level for the predicted SSB is not acceptable. One or more of the following may apply: the WTRU who has determined that a first predicted SSB beam may not satisfy the required accuracy, may select to use a second predicted SSB beam for the initial access procedure; the WTRU may follow the procedures considered for failed PRACH transmission; and/or the WTRU may continue the initial access procedure (e.g., via transmission of Msg3), and/or connects to the cell based on the beams that have the same spatial relations as the predicted beam (e.g., QCL-ed with the predicted beam).

In an example, the WTRU that has determined that a first predicted SSB beam may not satisfy the required accuracy, may select to use a second predicted SSB beam for the initial access procedure. The WTRU may stop and/or reject the ongoing initial access based on the first predicted beam. The WTRU may initiate a new initial access procedure based on the second predicted beam. The WTRU may select the second predicted beam based on the list of k best predicted SSB beams (e.g., ordered based on highest quality of RSRP, RSRQ, hypothetical BLER, and so forth). Based on the determined second best predicted SSB beam, the WTRU may initiate initial access (e.g., by sending the PRACH preamble) on the PRACH resources corresponding to the second best predicted SSB. In an example, the WTRU may follow the procedures considered for failed PRACH transmission. For the example the WTRU may follow the procedures of transmitting PRACH preamble based on the detected beam, waiting for legacy SSB burst with each SSB beam transmitted, rejecting the current cell and attempting to detect another SSB block in a different sync raster or another cell, and/or the like.

In an example, the WTRU may perform conditional connection. For example, the WTRU may continue the initial access procedure (e.g., via transmission of Msg3), and/or connect to the cell based on the beams that have the same spatial relations as the predicted beam (e.g., QCL-ed with the predicted beam). The WTRU may connect to a cell based on beams that have same spatial relations as the first predicted SSB to perform the new initial access procedure. The WTRU may indicate (e.g., to gNB) that the predicted beam (e.g., that is being used) is not the preferred beam (e.g., via a flag indication). The WTRU may indicate the preferred (e.g., predicted) beam via an indication (e.g., beam index). The WTRU may indicate the first predicted SSB via a beam index to perform the new initial access procedure. The WTRU may send the indications as part of initial access signaling (e.g., Msg3), or as part of indication signaling after connecting to the cell and switching from initial access procedure to the Connected mode (e.g., via UCI, MAC-CE, and so forth). After switching to the Connected-Mode, the WTRU may send a request to switch to the preferred beam or the first predicted SSB; or the WTRU may receive an indication (e.g., from gNB) to switch to another beam.

The comparison of the accuracy of a prediction may be performed based on at least two RAR messages. In an embodiment, a WTRU may receive more than one RAR messages, wherein the WTRU may compare one or more measured parameters for the received RAR messages to determine the accuracy of the predicted beams, and/or to determine, select, and/or indicate the best beam accordingly. In an example, the WTRU that has indicated more than one preferred SSB beam (e.g., including detected and/or predicted SSB beams, e.g., via a set of (combination) PRACH resources, as described herein (see Section 4.4, or Solution #1), may receive more than one RAR messages within the RAR reception window. In an example, the WTRU may receive a first RAR signaling (e.g., RAR PDCCH and/or RAR PDSCH) corresponding to a first detected SSB; the WTRU may receive a second RAR signaling (e.g., RAR PDCCH and/or RAR PDSCH) corresponding to a first predicted SSB, and so forth. In an example, the WTRU may determine the corresponding SSB based on the received Random Access Preamble ID (RAPID) detected from the received RAR message.

The WTRU may measure a first set of one or more beam quality parameters (e.g., RSRP, RSRQ, SINR, probability of LOS, etc.) based on the one or more reference signals received in the first RAR signaling (e.g., RAR received via a beam QCL-ed with the first detected SSB) (e.g., via RAR PDCCH DMRS, RAR PDSCH DMRS, and so forth); the WTRU may measure a second set of one or more beam quality parameters (e.g., RSRP, RSRQ, SINR, probability of LOS, etc.) based on the one or more reference signals received in the second RAR signaling (e.g., RAR received via a beam QCL-ed with the first predicted SSB) (e.g., via RAR PDCCH DMRS, RAR PDSCH DMRS, and so forth), and so forth.

In an embodiment, the WTRU may compare the measured sets of one or more parameters (e.g., the first set, the second set, and so forth). The WTRU may determine the best beam based on the beam with most favorable beam quality parameters (e.g., with RSRP, RSRQ, probability of LOS higher than corresponding thresholds, and/or theoretical BLER lower than the corresponding threshold, and so forth). The WTRU may use the selected best beam for the further initial access procedures (e.g., Msg3 transmission). In an embodiment (e.g., alternatively), the WTRU may compare the measured sets of one or more parameters (e.g., the first set, the second set, and so forth) with the predicted parameters for the predicted beam (e.g., RSRP, RSRQ, probability of LOS, and so forth) or for one or more predicted SSBs. In order to be able to compare, the WTRU may receive, determine, be provided, or (pre)configured (e.g., via MIB, SIB, etc.) with one or more parameters or configuration parameters, offset values, scaling rules, and/or scaling values to (re)evaluate and/or scale the measured sets of one or more parameters.

In an example, the WTRU may determine if the accuracy of the prediction is acceptable, for example if the difference between the measured parameters and the predicted parameters is in an acceptable range (e.g., lower than a corresponding threshold). If the accuracy is acceptable, the WTRU may go on with the initial access procedure (e.g., Msg3 transmission), and/or the WTRU may connect to the detected cell. In an example (e.g., otherwise), the WTRU may determine that the difference between one or more of the predicted parameters compared to corresponding measured, (re)evaluated, and/or scaled parameters is higher than corresponding thresholds. The WTRU may determine that the accuracy level for the predicted SSB is not in the acceptable range. The WTRU may perform one or more procedures, as described herein, including selecting a second predicted SSB beam, following the procedures considered for failed PRACH transmission, conditional connection, and/or the like.

What is claimed is:

1.-20. (canceled)

21. A wireless transmit/receive unit (WTRU) comprising:
a processor and memory, wherein the processor and memory are configured to:
receive an indication of a set of one or more transmitted synchronization signal blocks (SSBs) comprised in an SSB burst and an indication of a set of one or more skipped SSBs comprised in the SSB burst, wherein each of the one or more skipped SSBs is not transmitted by a base station in the SSB burst;
determine to send an indication that the WTRU wants to use a first skipped SSB of the set of one or more skipped SSBs;
transmit an indication of the first skipped SSB; and
receive at least one downlink transmission using a beam associated with the first skipped SSB.

22. The WTRU of claim 21, wherein the processor and memory are configured to:
receive configuration information associated with the set of one or more transmitted SSBs, wherein the configuration information comprises a list of candidate beams, wherein the list of candidate beams comprises the beam associated with the first skipped SSB.

23. The WTRU of claim 22, wherein the configuration information comprises beam indexes, an azimuth angle, an elevation angle, or a boresight angle.

24. The WTRU of claim 21, wherein the indication of the first skipped SSB comprises a random access preamble, the random access preamble is transmitted using a beam associated with a first transmitted SSB of the set of one or more transmitted SSBs, and the random access preamble or one or more random access resources used to transmit the random access preamble are indicative of the first skipped SSB.

25. The WTRU of claim 21, wherein the indication of the first skipped SSB comprises one or more random access resources, the one or more random access resources comprise a first random access resource and a second random access resource, the first random access resource is associated with a first transmitted SSB of the set of one or more transmitted SSBs, and the second random access resource is associated with the first skipped SSB.

26. The WTRU of claim 21, wherein the processor and memory are configured to receive a configuration indicating whether SSB skipping is enabled.

27. The WTRU of claim 21, wherein the processor and memory are configured to use an artificial intelligence (AI)/machine learning (ML) model to predict a list of preferred predicted SSBs from the set of one or more skipped SSBs.

28. The WTRU of claim 21, wherein the indication of the first skipped SSB comprises one or more random access resources that are based on the set of one or more transmitted SSBs, the set of one or more skipped SSBs, or a combination of the set of one or more transmitted SSBs and the set of one or more skipped SSBs.

29. The WTRU of claim 21, wherein the first skipped SSB of the set of one or more skipped SSBs is used for or after an initial access procedure.

30. The WTRU of claim 21, wherein the indication of the first skipped SSB comprises an indication sent in a random access message three using one or more random access resources that are indicative of the first skipped SSB.

31. A method implemented by a wireless transmit/receive unit (WTRU), the method comprising:
receiving an indication of a set of one or more transmitted synchronization signal blocks (SSBs) comprised in an SSB burst and an indication of a set of one or more skipped SSBs comprised in the SSB burst, wherein each of the one or more skipped SSBs is not transmitted by a base station in the SSB burst;
determining to send an indication that the WTRU wants to use a first skipped SSB of the set of one or more skipped SSBs;
transmitting an indication of the first skipped SSB; and
receiving at least one downlink transmission using a beam associated with the first skipped SSB.

32. The method of claim 31, further comprising:
receiving configuration information associated with the set of one or more transmitted SSBs, wherein the configuration information comprises a list of candidate beams, wherein the list of candidate beams comprises the beam associated with the first skipped SSB.

33. The method of claim 32, wherein the configuration information comprises beam indexes, an azimuth angle, an elevation angle, or a boresight angle.

34. The method of claim 31, wherein the indication of the first skipped SSB comprises a random access preamble, the random access preamble is transmitted using a beam associated with a first transmitted SSB of the set of one or more transmitted SSBs, and the random access preamble or one or more random access resources used to transmit the random access preamble are indicative of the first skipped SSB.

35. The method of claim 31, wherein the indication of the first skipped SSB comprises one or more random access resources, the one or more random access resources comprise a first random access resource and a second random access resource, the first random access resource is associated with a first transmitted SSB of the set of one or more transmitted SSBs, and the second random access resource is associated with the first skipped SSB.

36. The method of claim 31, further comprising:
receiving a configuration on whether SSB skipping is enabled.

37. The method of claim 31, further comprising:
using an artificial intelligence (AI)/machine learning (ML) model to predict a list of preferred predicted SSBs from the set of one or more skipped SSBs.

38. The method of claim 31, wherein the indication of the first skipped SSB comprises one or more random access resources that are based on the set of one or more transmitted SSBs, the set of one or more skipped SSBs, or a combination of the set of one or more transmitted SSBs and the set of one or more skipped SSBs.

39. The method of claim 31, wherein the first skipped SSB of the set of one or more skipped SSBs is used for or after an initial access procedure.

40. The method of claim 31, wherein the indication of the first skipped SSB comprises an indication sent in a random access message three using one or more random access resources that are indicative of the first skipped SSB.
